(19) United States
(12) Patent Application Publication
(10) Pub. No.: US 2024/0373513 A1
(43) Pub. Date: Nov. 7, 2024

(54) FLAT BATTERY PACK AND HEATED GARMENT COMMUNICATION

(71) Applicant: MILWAUKEE ELECTRIC TOOL CORPORATION, Brookfield, WI (US)

(72) Inventors: Matthew D. Strommen, Greendale, WI (US); Jonathan S. Pinske, Pewaukee, WI (US)

(21) Appl. No.: 18/650,812

(22) Filed: Apr. 30, 2024

Related U.S. Application Data
(60) Provisional application No. 63/464,011, filed on May 4, 2023.

(51) Int. Cl. H05B 1/02; A41D 13/005; A41D 19/015; H01M 50/247; H02J 7/00; H05B 3/34

(52) U.S. Cl. CPC H05B 1/0272; A41D 13/0051; H01M 50/247; H02J 7/00034; H02J 7/0047; H02J 7/00712; H02J 7/007192; H05B 3/342; A41D 19/01535; A41D 2400/12; H01M 2220/30; H02J 2207/30; H05B 2203/016; H05B 2203/036

(57) ABSTRACT

A power source for a heated garment. The power source includes a housing, one or more battery cells located within the housing, a first electrical interface provided on the housing for connecting the power source to the heated garment, and a first controller located within the housing and including an electronic processor, a memory, and a transceiver, the first controller coupled to the battery cells and the first electrical interface. The controller is configured to detect the heated garment coupled to the power source at the first electrical interface, receive, with the transceiver, a control signal from an external device, and provide the control signal to a second controller included in the heated garment.

### RELATED APPLICATIONS

This application claims the benefit of U.S. Provisional Patent Application No. 63/464,011, filed May 4, 2023, the entire content of which is hereby incorporated by reference.

### FIELD

The present application relates to heated garments and, in particular, a power source for heated garments.

### SUMMARY

Heated garments require input power to power heating elements. Compact battery packs provide the required input power to the heated garments. Traditionally, a heating level of a heated garment with multiple heating levels is controlled at the heated garment itself. For example, if the heated garment is a heated jacket, the heated jacket may include a button that a user can actuate to choose between discrete heating levels. A user may wear multiple heated garments. In such a scenario, each heated garment is powered via an individual battery pack, and the user may adjust the heating level of each individual garment to achieve desired heating levels through, for example, a dedicated button or other control for each heated garment.

The present disclosure provides, among other things, external control of one or more heated garments. For example, it may be advantageous to control a heated garment via communication between a battery pack (that controls a heater of a heated garment) and an external device, such as, for example, a portable user communication device (e.g., a mobile phone, tablet, computer, wearable device, or the like). The battery pack may be compact and reside in the heated garment. The compact size provides a minimal amount of additional weight and does not hinder a user wearing the heated garment. Heated garment communication could be achieved with wireless communication between the battery pack and the external device. It may also be advantageous for the battery pack to communicate with one or more heated garments to determine the status of the one or more heated garments. For example, bi-directional communication between the heated garment and the battery pack would allow for increased user control of the heated garment. Additionally, multiple heated garments would benefit from being able to be powered by the single battery pack and controlled via an external device.

The present disclosure further provides heater control in heated gear. For example, the heater may be controlled with a constant runtime to provide heat for as long as possible. The temperature of the heater may decrease overtime, but the heater maintains an output (i.e., some level of heating) for a predetermined time. As another example, the heater may be controlled with a constant temperature to provide a selected level of heat for as long as possible. The temperature remains constant for as long as possible before the battery pack runs out of power.

Embodiments described herein provide a power source for a heated garment. The power source includes a housing, one or more battery cells located within the housing, a first electrical interface provided on the housing for connecting the power source to the heated garment, and a first controller located within the housing and including an electronic processor, a memory, and a transceiver, the first controller coupled to the battery cells and the first electrical interface. The controller is configured to detect the heated garment coupled to the power source at the first electrical interface, receive, with the transceiver, a control signal from an external device, and provide the control signal to a second controller included in the heated garment.

Further embodiments described herein provide a method of providing a control signal to a heated garment. The method comprises detecting, with a first controller of a power source, the heated garment coupled to the power source at a first electrical interface, receiving, with a transceiver of the power source, a control signal from an external device, and providing, with the first controller of the power source, the control signal to a second controller of the heated garment.

Further embodiments described herein provide a system. The system comprises a heated garment and a power source. The heated garment includes a heater array and a first controller. The power source includes a housing, one or more battery cells located within the housing, a first electrical interface provided on the housing for connecting the power source to the heated garment, and a second controller located within the housing. The second controller includes an electronic processor, a memory, and a transceiver. The second controller is coupled to the battery cells and the first electrical interface. The second controller is configured to detect the heated garment coupled to the power source at the first electrical interface, receive, with the transceiver, a control signal from an external device, and provide the control signal to the first controller of the heated garment.

### BRIEF DESCRIPTION OF THE DRAWINGS

FIG. 1A illustrates a battery pack for communicating with and powering a heated garment, according to some embodiments.

FIG. 1B illustrates an internal view of the battery pack of FIG. 1A, according to some embodiments.

FIG. 1C illustrates an exploded view of the battery pack of FIG. 1A, according to some embodiments.

FIG. 2 illustrates a front view of a heated garment, according to some embodiments.

FIG. 3 illustrates a back view of a heated garment, according to some embodiments.

FIG. 4 illustrates another heated garment, according to some embodiments.

FIG. 5 is a block control diagram of the battery pack of FIG. 1, according to some embodiments.

FIG. 6 is a block control diagram of a heated garment, according to some embodiments.

FIG. 7 is a block diagram of a battery pack communication with heated garments, according to some embodiments.

FIG. 8A illustrates a first dual connector from the heated garment of FIG. 2, according to some embodiments.

FIG. 8B illustrates a first dual connector port for the battery packs of FIG. 1, according to some embodiments.

FIG. 8C illustrates a second dual connector from the heated garment of FIG. 2, according to some embodiments.

FIG. 8D illustrates a second dual connector port for the battery packs of FIG. 1, according to some embodiments.

FIG. 9 illustrates a user interface for the heated garment of FIG. 2, according to some embodiments.

FIG. 10 illustrates a user interface for the battery pack of FIG. 1, according to some embodiments.

FIG. 11 is a communication network for the battery pack of FIG. 1 and an external device, according to some embodiments.

FIG. 12 is a block diagram of an external device, according to some embodiments.

FIG. 13 is a flow chart illustrating a method of communicating with an external device, according to some embodiments.

FIG. 14 is a flow chart illustrating a method of operating the heated garment, according to some embodiments.

FIG. 15 is a flow chart illustrating a method of operating the heated garment for a constant runtime, according to some embodiments.

FIG. 16 is a flow chart illustrating a method of operating the heated garment for a constant temperature, according to some embodiments.

FIG. 17 illustrates constant runtime control and constant temperature control for the heated garment, according to some embodiments.

FIG. 18 illustrates a user interface of an external device for pairing the battery pack of FIG. 1 with an external device, according to some embodiments.

FIGS. 19A-19D illustrate user interfaces of an external device when the battery pack of FIG. 1 is paired with the external device, according to some embodiments.

FIGS. 20A-20C illustrate user interfaces of an external device for adjusting the heat zones and runtime of the heated garment, according to some embodiments.

FIG. 21 illustrates a user interface of an external device for adjusting notification settings, according to some embodiments.

FIG. 22 illustrates a protection circuit for the battery pack of FIG. 1A, according to some embodiments.

### DETAILED DESCRIPTION

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

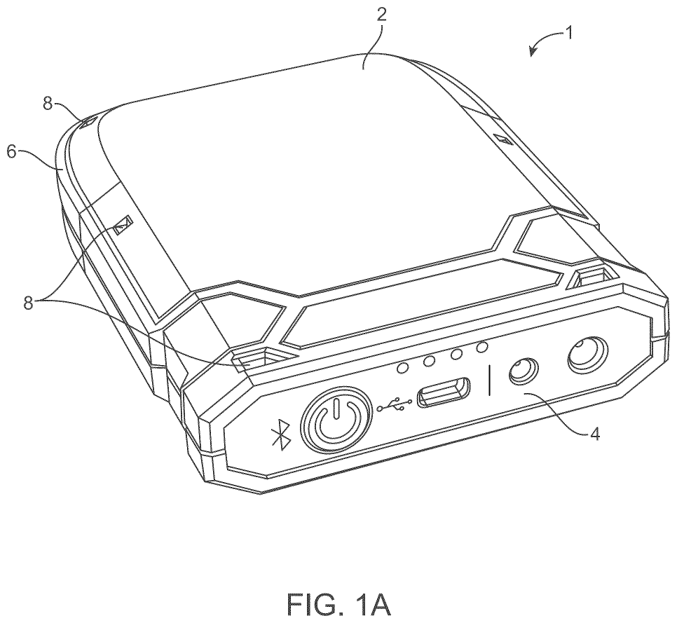

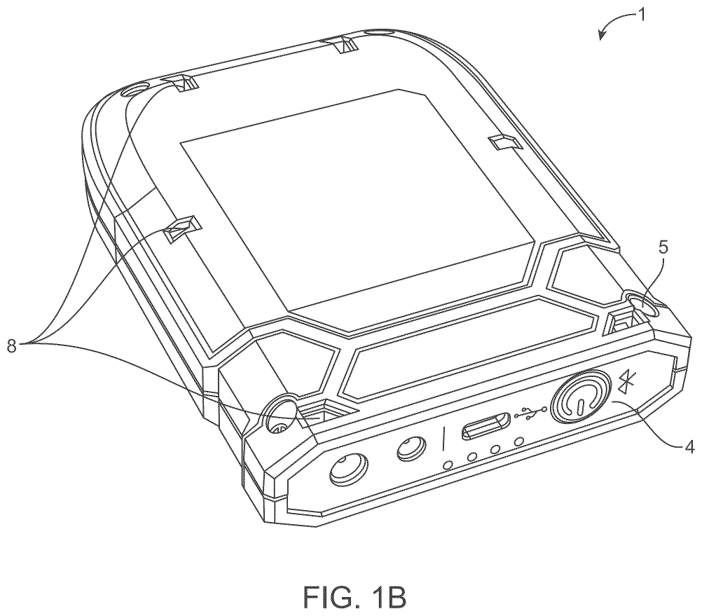

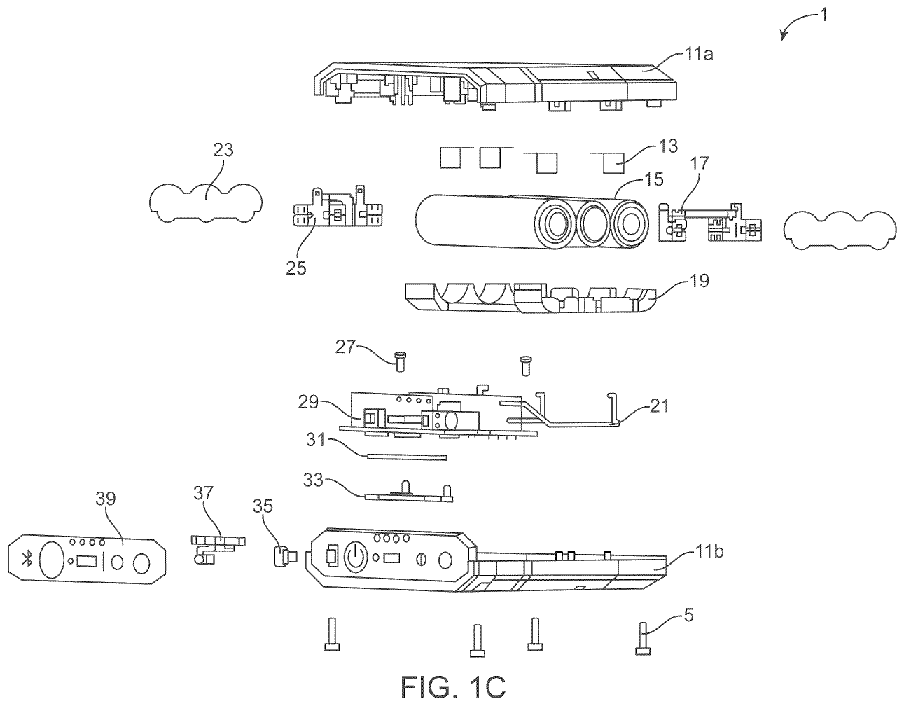

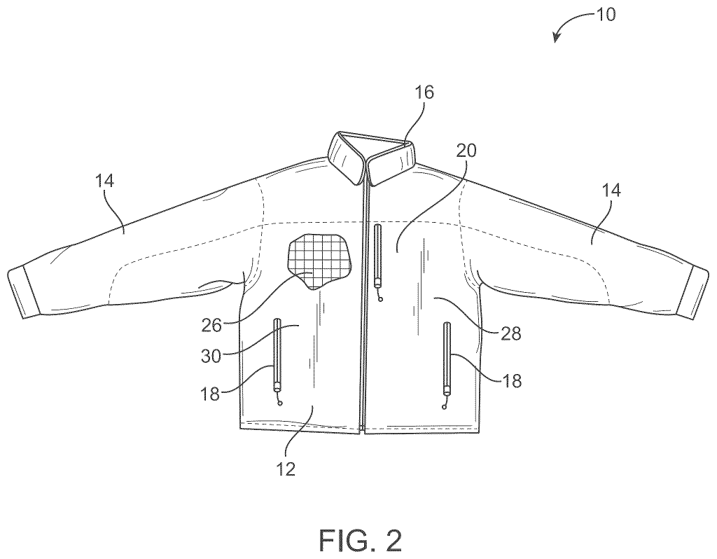

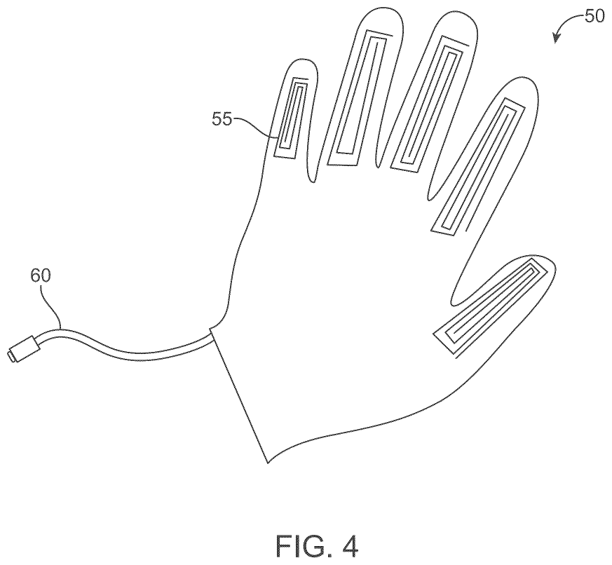

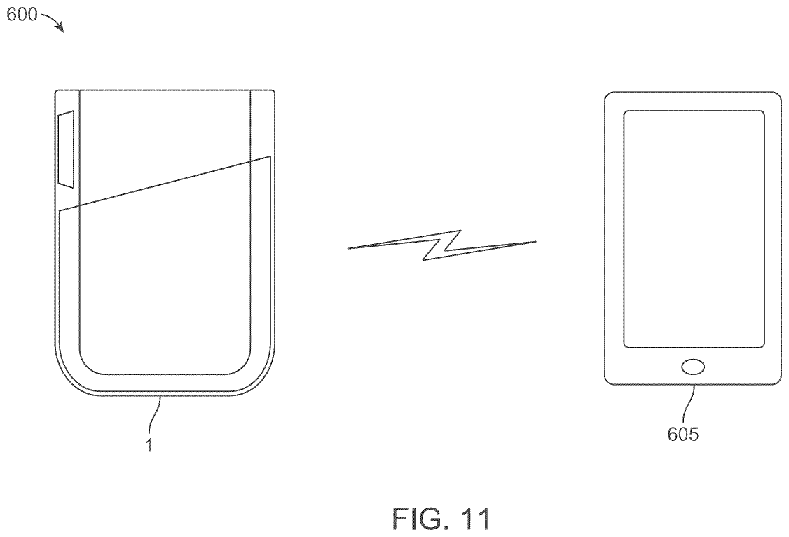

FIG. 1A illustrates a battery pack 1 for providing power to and communicating with a heated garment, such as heated jacket 10 (FIG. 2) and/or heated glove 50 (FIG. 4) and communicating with an external device, such as external device 605 (FIG. 11). The battery pack 1 includes a housing 2 and an interface portion 4 for connecting the battery pack 1 to a heated garment (e.g., the heated jacket 10 and/or heated glove 50). Additionally or alternatively, in some embodiments, the battery pack 1 may be configured to wirelessly provide power to the heated garment. For example, the battery pack 1 (e.g., the interface portion 4 in some embodiments) may include one or more inductors or other wireless charging circuitry that can wirelessly provide power to a heated garment with wireless power capabilities. In some embodiments, the battery pack 1 includes a connection port for input power to charge rechargeable battery cells withing the housing 2. For example, the connection port may be one of a Universal Serial Bus (USB), Universal Serial Bus Type-C (USB-C), or a Universal Serial Bus Power Delivery (USB-PD) port.

In some embodiments, the housing 2 is a hard plastic exterior. The housing 2 may include six sides: a first flat side along a first plane, a second flat side along a second plane parallel to the first plane, a first long side along a third plane perpendicular to the first plane and the second plane, a second long side along a fourth plane parallel to the third plane, a back side along a fifth plane perpendicular to the third plane, and a front side including the interface portion 4 along a sixth plane parallel to the fifth plane and perpendicular to the first plane and the third plane. The back side may be joined to the first long side and the second long side with a rounded vertex. The front side may be joined to the first long side and the second long side with a substantially right-angled vertex. In some embodiments, the housing 2 may include an over-mold 6 along the first long side, the back side, and the second long side. The over-mold 6 may be a rubber material that provides increased grip and durability (e.g., shock-absorbing drop protection). In some embodiments, the first flat side includes weep holes 8. For example, six weep holes may be provided along an interior edge of the first flat side. The weep holes 8 may allow gas or liquid to escape from inside the battery pack 1. The first long side and the second long side may include indents at an edge adjacent to the interface portion 4 of the front side. For example, the indents may provide a user with a gripping surface for the battery pack 1. In some embodiments, the front side may include a cover portion integrated into the housing 2. For example, cover portion may include deformable plastic features and windows.

In some embodiments, the width of the first long side and the second long side may be in the range of 20-25 millimeters (mm). In some embodiments, the length of the first long side and the second long side may be in the range of 110-175 mm. In some embodiments, the width of the first flat side and the second flat side may be in the range of 65-85 mm. The weight of the battery pack 1 may in the range of 0.4-1.2 pounds (lbs).

In some embodiments, the battery pack 1 includes one or more lithium-ion battery cells, such as battery cells 15 (FIG. 1C). In other embodiments, the battery pack 1 may be of a different chemistry, for example, nickel-cadmium, nickel-metal hydride, and the like. The battery cells 15 may take various shapes and configurations and are not limited to the cylindrical configuration illustrated in FIG. 1C. For example, in some embodiments, the battery cells 15 may include one or more cylindrical cells, one or more pouch cells, one or more prismatic cells, or a combination thereof. In some embodiments, the battery pack 1 may include anywhere in the range of three to six battery cells 15 provided in one or two layers within the battery pack 1. In the illustrated embodiment, the battery pack 1 is a 12V battery pack outputting a constant 12V output. In other embodiments, the output voltage level of the battery pack 1 may be different. For example, the battery pack 1 may be a 4V battery pack, 28V battery pack, 40V battery pack, or another voltage. The battery pack 1 may also have various capacities (e.g., 3, 4, 5, 6, 8, or 12 A/hr). The output of the battery cells 15 may be in the range of 3.0-6.0 Ampere-hours (Ah).

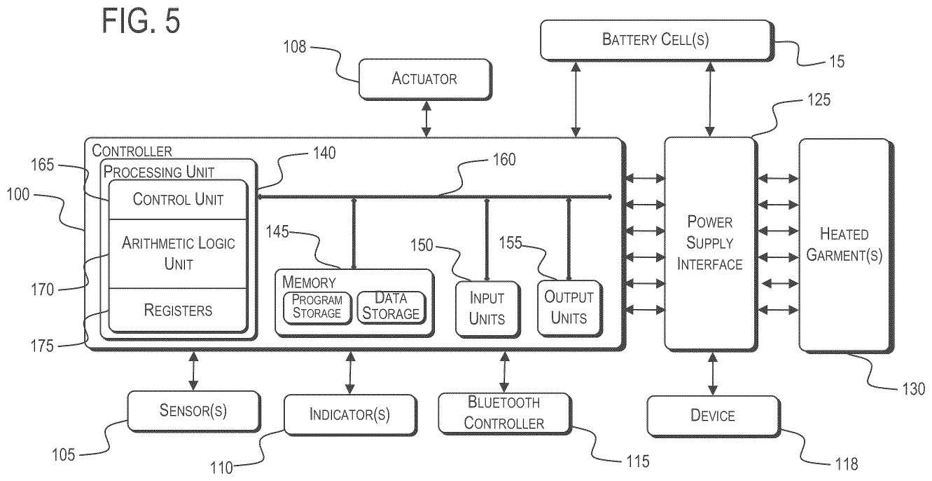

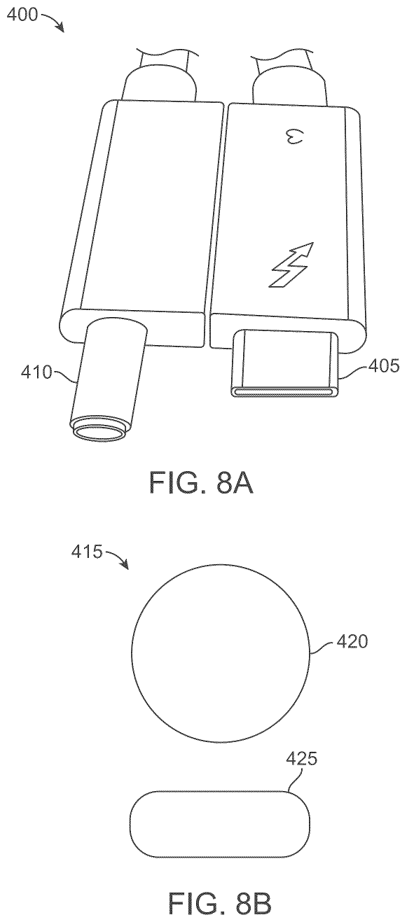

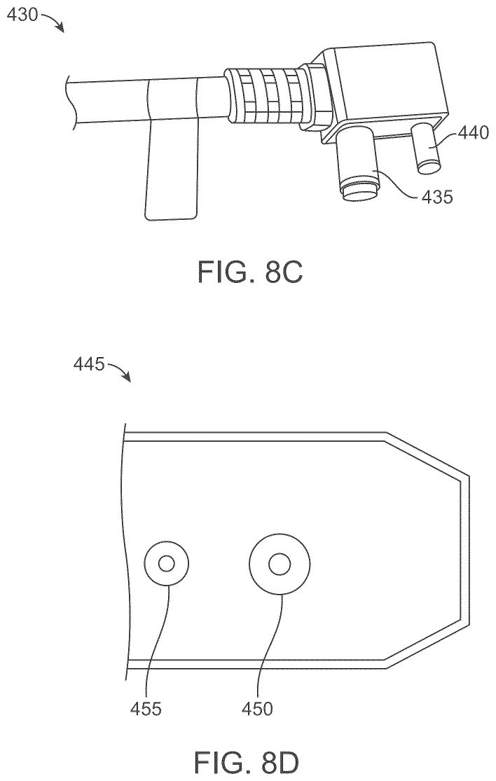

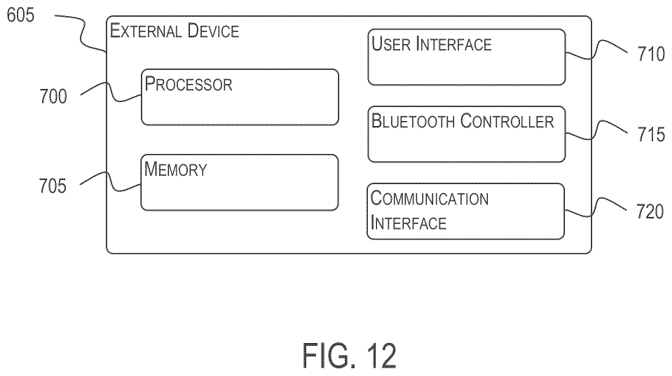

In some embodiments, the interface portion 4 may include one or more power connection ports, such as first port 420, 450 (FIG. 8B, FIG. 8D, respectively). In some embodiments, the battery pack 1 also includes one or more data connection ports, such as second port 425, 455 (FIG. 8B, FIG. 8D, respectively), coupled to a control unit, such as controller 100 (FIG. 5), to communicate with the heated garment. In some embodiments, the battery pack 1 includes a wireless communication controller, such as Bluetooth® controller 115 (FIG. 5), that may wirelessly communicate with a wireless communication controller of the external device 605, such as Bluetooth® controller 715 (FIG. 12). In some embodiments, the battery pack 1 wirelessly communicates with the heated garment via Bluetooth®. Per the Bluetooth® protocol, the battery pack 1 and the external device 605 may communicate using radio frequency waves from 2.402 GHz to 2.48 GHz. The Bluetooth® controller 115, the Bluetooth® controller 715, or both may communicate using the Bluetooth® Low Energy (BLE) protocol. It should be understood that the battery pack 1 and the external device 605 may use other communication protocols, such as, for example, other short-range wireless communication protocols, and is not limited to the Bluetooth® protocol. For example, in some embodiments, a near field communication protocol may be used in some embodiments.

FIG. 1B illustrates an internal view of the battery pack 1. For example, the internal view may be a view of the battery pack 1 with the removal of an outer plastic shell that is a part of the housing 2. As illustrated in FIG. 1B, the weep holes 8 extend through the outer plastic shell of the housing 2 and are provided into the interior of the battery pack 1. The interior of the battery pack 1 houses the one or more battery cells 15. The housing 2 may include a top housing, such as top housing 11a (FIG. 1C), and a bottom housing, such as bottom housing 11b (FIG. 1C), that are joined together with screws 5. For example, the top housing 11a and the bottom housing 11b may be joined together with four screws 5 at four vertices of the battery pack 1. Other configurations of the housing 2 are possible including additional or fewer portions covering one or more different surfaces and using different joining mechanisms.

FIG. 1C illustrates an exploded view of the battery pack 1. The battery pack 1 includes the top housing 11a, the bottom housing 11b, one or more first positioning elements 13, the one or more battery cells 15, a first metal strap 17, a rubber pad 19, wiring 21, one or more screws 5, a second positioning element 23, a second metal strap 25, one or more interior screws 27, a printed circuit board assembly (PCBA) 29, a sheet 31, a heat sink 33, one or more indicators, such as one or more light emitting diodes (LEDs) 35, a light pipe 37, and a transparent sticker 39. In some embodiments, the one or more first positioning elements 13 and the second positioning element 23 are comprised of a polyester film, such as Mylar®.

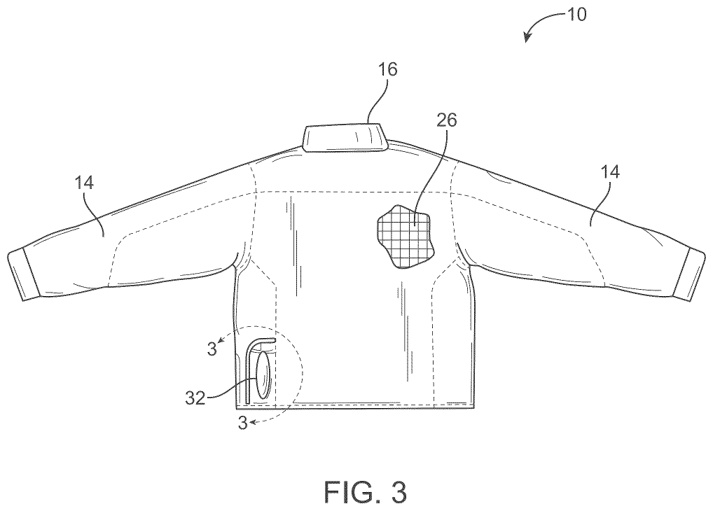

FIG. 2 illustrates a heated garment 10. The illustrated heated garment 10 is a jacket. The jacket 10 may be constructed in various sizes to fit a variety of users. The jacket 10 includes typical jacket features, such as, for example, a torso body 12, two arms 14, a collar 16, and one or more front pockets 18. As illustrated in cutaway portions of FIGS. 2 and 3, the jacket 10 includes a heater array 26. In some embodiments, the heater array 26 is disposed in both a left portion 28 and a right portion 30 of the torso body 12. In some embodiments, the heater array 26 may extend into the arms 14 and/or collar 16. The heater array 26 may be configured to generate heat based on a received DC voltage from the battery pack 1. For example, the heater array 26 may be a resistive heater array. However, other heater array types are also contemplated. In other embodiments, the jacket 10 may include a first heater array and second heater array arranged as an upper module and a lower module, respectively. In the illustrated embodiment, the heater array 26 is controlled by one of the battery pack 1 and the heated jacket 10 based on input from the external device 605. In other embodiments, multiple heater arrays may be controlled individually via a single control input or multiple control inputs. For example, the multiple heater arrays may be isolated and controlled by the battery pack 1 based on input from the device 605. The heater array 26 may include resistive heating coils formed of carbon fibers, high density carbon fibers, or other heating devices. In some embodiments, the heated jacket 10 is configured to maintain a temperature of up to 110 degrees (°) Fahrenheit, although in other embodiments, lower or greater temperatures are possible depending upon the type of heater array 26.

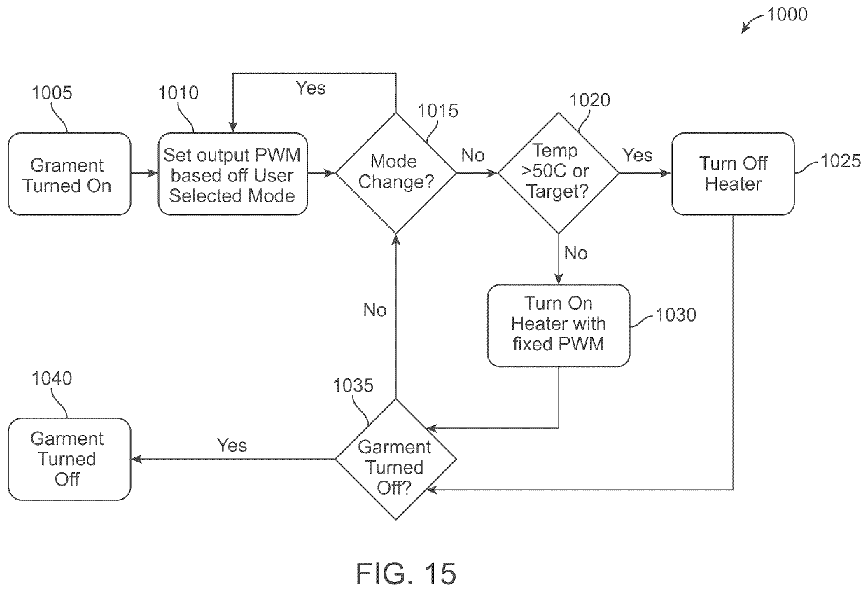

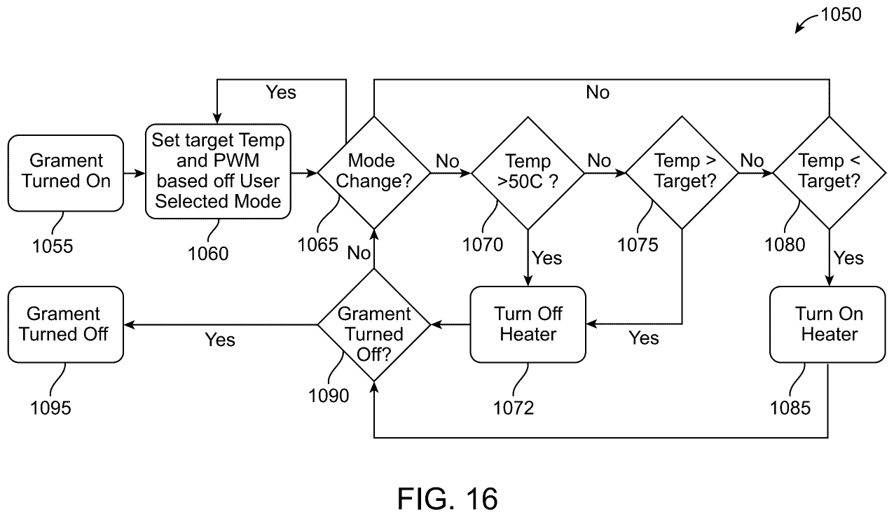

In some embodiments, the heater array 26 may include a negative temperature coefficient thermistor (NTC) or a positive temperature coefficient thermistor (PTC) to determine temperature. For example, the NTC or PTC is coupled to the heater array 26 to determine the heater array 26 temperature. In some embodiments where a carbon fiber element is implemented in the heated garment, an NTC or PTC may be used. The NTC or PTC may be added to the heater array 26 on or close to the carbon fiber element and an ambient surface of the garment. In some embodiments where a conductive ink heater is implemented in a heated garment, the current required to provide heat to the heater array may be determined by a current sensor. For example, a PTC may be provided to the heater array which reduce the current drawn by the heater array as the temperature of the heater array increases. The heater array 26 may be controlled to output a constant runtime and/or a constant temperature (FIGS. 15-16).

As illustrated in cutout 3-3 of FIG. 3, the heated jacket 10 includes a compartment 32 located on a lower portion of the back torso body. The compartment 32 houses an electrical component, such as a battery pack 1, which may be held within a battery holder (not shown). The heated jacket 10 includes a connector, such as first dual connector 400 (FIG. 8A) or second dual connector 430 (FIG. 8C), for connecting the heater arrays 26 to the battery pack 1.

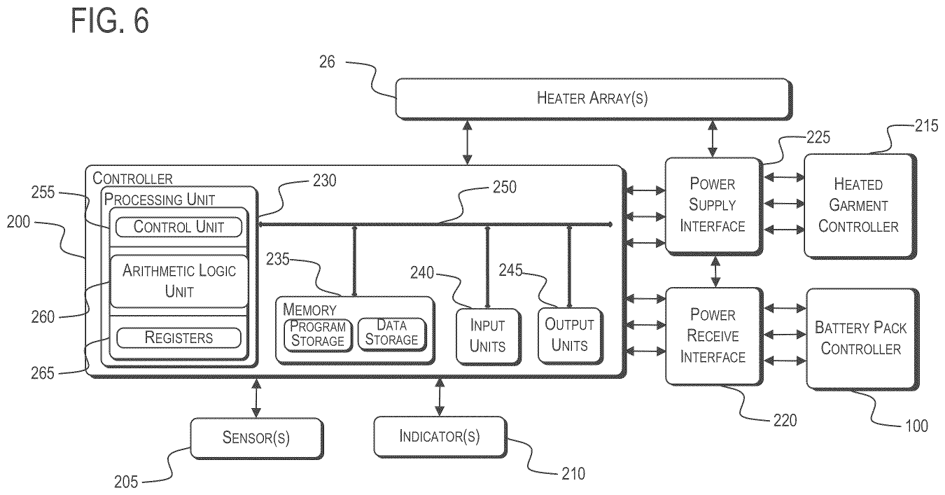

In some embodiments, the heated jacket 10 may include a controller, such as controller 200 (FIG. 6). The controller 200 may communicate with a battery pack controller, such as controller 100 (FIG. 5). In some embodiments, the heated jacket 10 may include at least one connection port for connecting to other heated garments. For example, the connection port(s) may be a USB, USB-C, or USB-PD port. The connection port(s) may be located on the torso body 12, arms 14, and/or collar 16 of the heated jacket 10. Garments connected to the heated jacket 10 via the connection port may receive input power from the battery pack 1 and may be controlled by the battery pack 1 (specifically, by the battery pack controller 100) that is connected to the heated jacket 10.

FIG. 4 illustrates another heated garment 50. The illustrated heated garment 50 is a heated glove. The heated glove 50 includes a heater array 55 and a connector 60. For example, the connector 60 may be a USB, USB-C, or USB-PD plug. The connector 60 may electrically and optionally, communicatively couple the heated glove 50 to the heated jacket 10. The heater array 55 may be powered and controlled by the battery pack 1 that is coupled to the heated jacket 10. For example, the heater array 55 may be able to provide varying heating levels to a user wearing the heated glove 50 based on input from the battery pack 1 that receives input from the external device, such as the external device 605 (FIG. 11). In some embodiments, the heated glove 50 may be a mitten.

A controller 100 for the battery pack 1 is illustrated in FIG. 5. The controller 100 is electrically and/or communicatively connected to a variety of modules or components of the battery pack 1. For example, the illustrated controller 100 is connected to one or more sensors 105 (which may include, for example, one or more current sensors, voltage sensors, temperature sensor, etc., or a combination thereof), an actuator 108, one or more indicators 110, a wireless communication (e.g., Bluetooth®) controller 115, one or more battery cell(s) 15, and a power supply interface 125.

The controller 100 includes a plurality of electrical and electronic components that provide power, operational control, and protection to the components and modules within the controller 100 and/or battery pack 1. For example, the controller 100 includes, among other things, a processing unit 140 (e.g., a microprocessor, an electronic processor, an electronic controller, a microcontroller, or another suitable programmable device), a memory 145, one or more input units 150, and one or more output units 155. In some embodiments, the processing unit 140 includes, among other things, a control unit 165, an arithmetic logic unit (“ALU”) 170, and a plurality of registers 175 (shown as a group of registers in FIG. 5), and is implemented using one or more computer architectures (e.g., a modified Harvard architecture, a von Neumann architecture, etc.). The processing unit 140, the memory 145, the input units 150, and the output units 155, as well as the various modules connected to the controller 100 are connected by one or more control and/or data buses (e.g., common bus 160). The control and/or data buses are shown generally in FIG. 5 for illustrative purposes. The use of one or more control and/or data buses for the interconnection between and communication among the various modules and components would be known to a person skilled in the art in view of the embodiments described herein.

The memory 145 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 140 is connected to the memory 145 and executes software instruction that are capable of being stored in a RAM portion of the memory 145 (e.g., during execution), a ROM portion of the memory 145 (e.g., on a generally permanent basis), or another non-transitory computer readable medium, such as another memory or a disc. Software included in the implementation of the battery pack 1 can be stored in the memory 145 of the controller 100. The software includes, for example, firmware, one or more applications, program data, filters, rules, one or more program modules, and other executable instructions. The controller 100 (e.g., the processing unit 140) is configured to retrieve from the memory 145 and execute, among other things, instructions related to the control processes and methods described herein. In other embodiments, the controller 100 includes additional, fewer, or different components.

The actuator 108 may be a power button, such as power button 514 (FIG. 10). The actuator 108 may provide a signal to the controller 100 when a user depresses the power button 514. For example, the signal may be an ON/OFF signal for providing power to or ceasing the power to a device 118 coupled to the power supply interface 125 (described below with respect to FIG. 5). In some embodiments, the battery pack 1 may charge a device 118 (e.g., a mobile phone, a power tool, a laptop, a tablet, etc.). The battery pack may provide 15 W of discharge power. As another example, when a user holds down the power button 514, the wireless communication controller 115 may pair with an external device 605.

The indicators 110 receive control signals from the controller 100 to turn ON and OFF or otherwise convey information based on different states of the battery pack 1. For example, the indicators 110 may display the power level of the battery cells 15, that the wireless communication controller 115 is paired with an external device 605, or that the wireless communication controller 115 is transmitting and/or receiving information from the external device 605. The indicators 110 include, for example, one or more light-emitting diodes (LEDs), a display screen (e.g., an LCD display), or a combination thereof. The display/indicator(s) 110 may also include additional elements to convey information to a user through one or more audible outputs, tactile outputs (e.g., a speaker), or a combination thereof. The display/indicator(s) 110 may also be referred to as an output device configured to provide an output to a user. In some embodiments, the indicators 110 may illuminate to display a power level of the battery cells 15 when a heated garment 130 is connected to the power supply interface 125 based on a signal from the power supply interface 125. In some embodiments, the controller 100 determines that a heated garment 130 is connected to the power supply interface 125 and automatically illuminates the indicators to display a power level of the battery cells 15.

The wireless communication controller 115, or wireless controller, includes a transceiver that communicates with a wireless-communication (e.g., Bluetooth®) enabled device, such as external device 605 (FIG. 11). The wireless communication controller 115 may transmit information regarding components of the battery pack 1, a status of the battery pack 1, and/or information about the heated garment 10. For example, the wireless communication controller 115 may transmit information such as the temperature of the heating zones, the type of heated garment coupled to the battery pack 1, heating zones, and/or preset information to the external device 605 by communicating with the wireless communication controller of the external device 605, such as Bluetooth® controller 715 (FIG. 12). The wireless communication controller 115 may receive control signals from the external device 605. In some embodiments, a control signal includes data defining a requested operating state of the heated garment 10 and, thus, may be referred to as a “heated garment control signal.” For example, the data may define one or more temperature set points, one or more heating zones of the heater array to activate/deactivate, a heater array runtime, an ON/OFF status of the heater array or zones thereof, a selected operating mode (e.g., low, medium, high) of the heater array, a lockout state of the heated garment 10, or a combination thereof. As noted above, in some embodiments, the wireless communication controller 115 communicates with the external device 605 employing the Bluetooth® or BLE protocol. Therefore, in some embodiments, the external device 605 and the battery pack 1 are within a communication range (i.e., in proximity) of each other while they exchange information.

The power supply interface 125 is connected to the controller 100 and couples to one or more heated garments 130 (e.g., heated jacket 10 and/or heated glove 50) and a device 118. In some embodiments, the power supply interface 125 includes a first connection port, such as a first dual connector port 415 (FIG. 8B) or a second dual connector port 445 (FIG. 8D), that couples to the heated garment 130 and a second connection port, such as USB-C port 518 (FIG. 10), that couples to the device 118. The power supply interface 125 includes a combination of mechanical (e.g., interface portion 4 (FIG. 1)) and electrical components configured to and operable for interfacing (e.g., mechanically, electrically, and communicatively connecting) the battery pack 1 with the heated garments 130. The power supply interface 125 transmits the power from the battery cells 15 to the heated garments 130 and/or device 118. The power supply interface 125 includes active and/or passive components (e.g., voltage step-down controllers, voltage converters, rectifiers, filters, etc.) to regulate or control the power transmitted to the heated garments 130 and/or device 118.

The controller 100 may dynamically adjust the heating level of a heated garment that is connected to the controller 100 via the power supply interface 125. For example, based on an input received from the external device 605 via the wireless communication controller 115 (e.g., a requested runtime of the heater array 26 in the heated jacket 10) and the amount of power left in the battery cells 15, the controller 100 may adjust the heating level of the heater array 26 of the connected heated garment to be able to operate the heater array 26 for the requested runtime. In the case that a heated garment, such as heated glove 50, is coupled to the heated jacket 10, the controller 100 may further dynamically adjust the heating levels of the heater array 26 of the jacket 10 and the heater array 55 of the glove to be able to operate the heater arrays 26, 55 for the requested runtime.

The controller 100 may also adjust specific heating zones of the heated garment, such as the heated jacket 10 (FIG. 2). A user may adjust which heat zones of the heated garment are active on the external device 605. The external device 605 communicates the heating zones that are to be active to the controller 100 via the wireless communication controller 115. For example, the user may adjust for various heat settings in different zones. Heat settings may include a heating level of the heating zones and the time that the heating zone is active. For example, the heater array located on the front of the heated jacket 10 may be separately controlled from the heater array located on the back of the heated jacket 10. As such, the user may adjust, via the external device 605, the heating level of the front heater array while maintaining the heating level of the back heater array. The controller 100 receives the adjustment by the user via the wireless communication controller 115 and controls the heater arrays accordingly. In some embodiments, a user may adjust a heating zone of a second heated garment, such as the heated glove 50 (FIG. 4), coupled to the heated jacket on the external device 605. For example, as described below, the external device 605 may execute a heated gear app that generates one or more graphical user interfaces that provide information to a user regarding one or more connected heated garments, allow the user to adjust various heating parameters of connected heated garments, or a combination thereof. In some embodiments, the heated gear app may provide one or more graphical user interfaces associated with a particular connected heated garment or may provide one or more graphical user interfaces that combine information or controls for multiple connected heated gear, which may allow a user to efficiently set heating parameters (e.g., set all heated garments to the same heating level through a single user interface or single input mechanism).

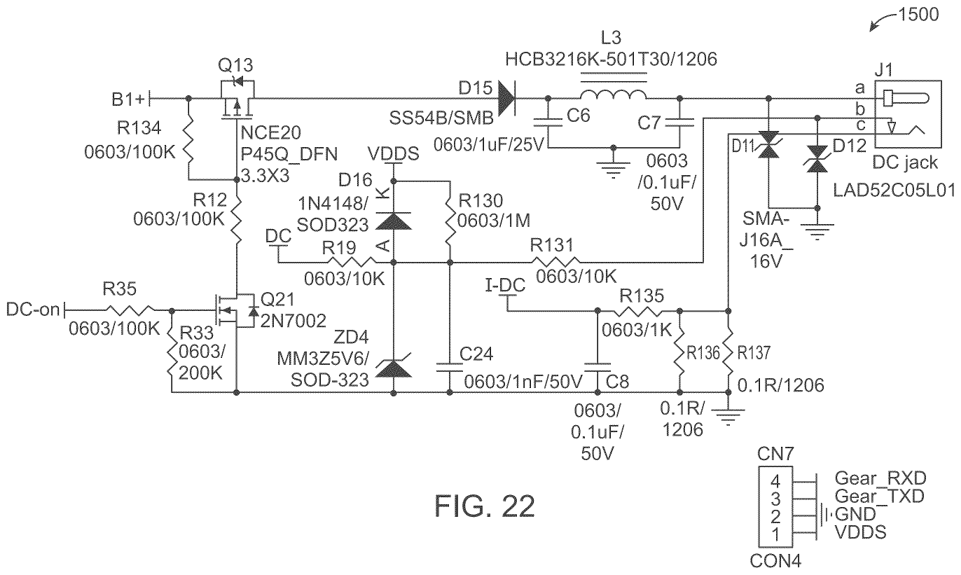

In some embodiments, the controller 100 may receive input from a current sensor. The current sensor may receive a signal from the heater array of the heated garment. For example, the current of the heater may decrease as the temperature of the heater increases. Based on the sensed current and thus the sensed temperature, the temperature of the heaters may be automatically adjusted to a preset temperature. Also, the battery pack 1 will have an extended life in warmer environments since less heat is needed, and, thus, the controller 100 may adjust the temperature of the heaters based on the ambient temperature and/or the determined temperature of the heater. The current sensor may also provide an over-current signal to the controller 100 that the controller 100 may use to deactivate circuit components that provide power to the heater array 26. Over-current protection for the battery pack 1 will be described with respect to FIG. 22.

In some embodiments, the controller 100 includes a feedback loop that automatically adjusts the temperature of the heated garment without input from a user via the external device 605. For example, the feedback loop may automatically adjust the heating levels of the heated garment based on a constant runtime or a constant temperature. A constant runtime control will be described below with respect to FIG. 15. A constant temperature control will be described below with respect to FIG. 16.

A controller 200 for a heated garment is illustrated in FIG. 6. The controller 200 is electrically and/or communicatively connected to a variety of modules or components of the heated garment, such as heated jacket 10 (FIG. 2). For example, the illustrated controller 200 is connected to one or more sensors 205 (which may include, for example, current sensors, voltage sensors, temperature sensor, timers, etc., or a combination thereof), one or more indicators 210, one or more heater arrays 26, a power receive interface 220, and a power supply interface 225. In some embodiments, the controller 200 may be connected to a heated garment wireless communication controller (not shown) included in the heated garment. For example, the heated jacket 10 may wirelessly communicate with the battery pack 1, the external device 605, or both via the heated garment wireless communication controller. In some embodiments, the heated jacket 10 may directly receive control signals from the external device 605 without the battery pack 1 facilitating communication between the heated jacket 10 and the external device 605.

The controller 200 includes a plurality of electrical and electronic components that provide power, operational control, and protection to the components and modules within the controller 200 and/or heated garment. For example, the controller 200 includes, among other things, a processing unit 230 (e.g., a microprocessor, an electronic processor, an electronic controller, a microcontroller, or another suitable programmable device), a memory 235, input units 240, and output units 245. The processing unit 230 includes, among other things, a control unit 255, an arithmetic logic unit (“ALU”) 260, and a plurality of registers 265 (shown as a group of registers in FIG. 2), and is implemented using one or more computer architecture (e.g., a modified Harvard architecture, a von Neumann architecture, etc.). The processing unit 230, the memory 235, the input units 240, and the output units 245, as well as the various modules connected to the controller 200 are connected by one or more control and/or data buses (e.g., common bus 250). The control and/or data buses are shown generally in FIG. 6 for illustrative purposes. The use of one or more control and/or data buses for the interconnection between and communication among the various modules and components would be known to a person skilled in the art in view of the embodiments described herein.

The memory 235 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 230 is connected to the memory 235 and executes software instruction that are capable of being stored in a RAM portion of the memory 235 (e.g., during execution), a ROM portion of the memory 235 (e.g., on a generally permanent basis), or another non-transitory computer readable medium, such as another memory or a disc. Software included in the implementation of the heated garment can be stored in the memory 235 of the controller 200. The software includes, for example, firmware, one or more applications, program data, filters, rules, one or more program modules, and other executable instructions. The controller 200 is configured to retrieve from the memory 235 and execute, among other things, instructions related to the control processes and methods described herein. In other embodiments, the controller 200 includes additional, fewer, or different components.

The indicators 210 receive control signals from the controller 200 to turn ON and OFF or otherwise convey information based on different states of the heated garment 10. For example, the indicators 210 may display that the heater array 26 is ON, that the battery pack 1 is out of power, etc. The indicators 210 include, for example, one or more light-emitting diodes (LEDs), a display screen (e.g., an LCD display), or a combination thereof. The display/indicator(s) 210 may also include additional elements to convey information to a user through one or more audible outputs, tactile outputs (e.g., a speaker), or a combination thereof. The display/indicator(s) 210 may also be referred to as an output device configured to provide an output to a user.

The power receive interface 220 is connected to the controller 200 and couples to the battery pack controller 100 to receive power from the battery pack 1. The power receive interface 220 includes a combination of mechanical (e.g., a connection port) and electrical components configured to and operable for interfacing (e.g., mechanically, electrically, and communicatively connecting) the heated garment with the battery pack 1. In some embodiments, the power receive interface 220 also receives data from the battery pack controller 100. For example, the controller 200 may receive a control signal including data from the battery pack controller 100 via the power receive interface 220. However, in other embodiments, a separate interface may be used to communicate data between the battery pack controller 100 and the heated garment controller 200, including, for example, a wireless communication channel in some embodiments. In some embodiments, the control signal may be the same signal received by the controller 100 from the external device 605. Alternatively, in some embodiments, the control signal may be processed by the battery pack controller 100 before being provided to the controller 200. For example, the controller 200 may receive data indicative of how much power the controller 200 should provide to a heating zone of the heater array 26, based on the control signal provided by the external device 605 to the battery pack controller 100. The controller 200 may use this data to set a power draw from the battery pack 1, control the one or more indicators on the heated garment to represent a current heating state or level, or the like.

The power supply interface 225 is connected to the controller 200 and couples to a heated garment controller 215. The power supply interface 225 supplies power from the battery pack 1 to another heated garment (i.e., the heated garment controller 215 included in such “other” heated garment). In some embodiments, the heated garment controller 215 may include at least some of the same components as the controller 200. As noted, the heated garment controller 215 is within a heated garment separate from the heated garment including the controller 200. For example, the controller 200 may be included in the heated jacket 10 (FIG. 2) and the heated garment controller 215 may be included in the heated glove 50 (FIG. 4). The power supply interface 225 includes a combination of mechanical (e.g., a connection port) and electrical components configured to and operable for interfacing (e.g., mechanically, electrically, and communicatively connecting) the heated garment with another heated garment.

In some embodiments, the power supply interface 225 facilitates both power and data transfer to the heated garment controller 215. However, in other embodiments, a separate interface may be used to communicate information between the controller 200, the battery pack 1, or other components of the heated garment 10 and the heated garment controller 215, including, for example, a wireless communication connection in some embodiments. For example, the battery pack controller 100 may provide a control signal (e.g., processed or unprocessed) to the heated garment controller 215 via the controller 200. The control signal may include a portion associated with the controller 200 as well as a portion associated with the heated garment controller 215 and such portions may be associated with unique identifiers of each controller, which may allow the controller 200, the power supply interface 225, or other component in the heated garment 10 to determine what portion of the signal is intended for what controller and, as such, may forward the portion designated for the heated garment controller 215 via the power supply interface 225. In some embodiments, rather than indirectly communicating with the heated garment controller 215 through the controller 200, the battery pack 1 may directly communicate with the heated garment controller 215 via one or more wired or wireless communication channels.

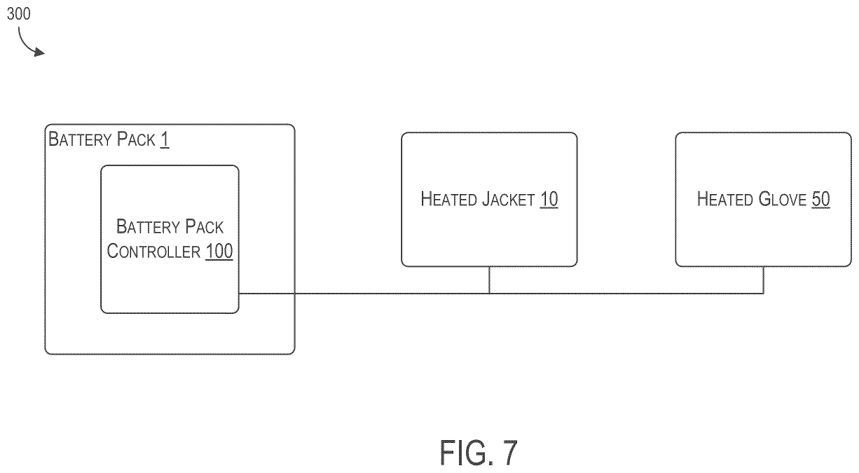

FIG. 7 is a block diagram 300 of the battery pack 1 communicating with heated garments, including the heated jacket 10 and the heated glove 50. In some embodiments, the battery pack 1 is controlled by an external device, such as device 605 (FIG. 11). For example, the external device 605 may be a mobile phone, tablet, or computer that has Bluetooth® or other wireless capabilities. In particular, the battery pack controller 100 communicates with the controllers of the heated garments, such as controller 200 and heated garment controller 215 (FIG. 6). The battery pack controller 100 may send information to the external device 605 by the wireless communication controller 115 communicating with a wireless communication controller of the device, such as Bluetooth® controller 115 (FIG. 12). For example, the battery pack 1 may communicate the current state of charge and/or the overall capacity of the battery pack 1 to the external device 605 using Bluetooth®.

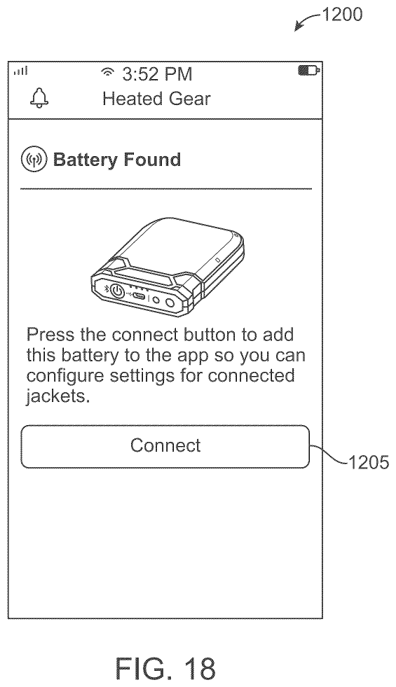

When the battery pack 1 is connected to the heated jacket 10 and the heated glove 50, the battery pack 1 may communicate to the external device 605 what garments are connected to the battery pack 1. A user may interface with the external device 605 to control aspects of the heated garments when the heated garments are connected to the battery pack 1, via the Bluetooth® controller 115. In some embodiments, the external device 605 may include an application that provides one or more graphical user interfaces (FIGS. 18-21) for receiving input for controlling the battery pack 1 and the heated garments. For example, the user may adjust heat settings (e.g., heating levels, heating zones, runtime, etc.) of the heated garments via one or more graphical user interface provided via the application on the external device 605. The adjusted heat settings are communicated to the battery pack 1 via the Bluetooth® controller 115 which then controls the heated garments through the power supply interface 125.

In addition to controlling the heated garments through the power supply interface 125, the controller 100 receives information on operating conditions of the heated garments. Controller 100 may receive temperature information (e.g., current temperature, set temperature, etc.), garment information (e.g., type of garment, serial number of the garment, unique identifier of the garment, etc.), zone information (e.g., which zones are active, how many zones, etc.), preset information, or a combination thereof. The information is used by the controller 100 to determine the amount of power being consumed by the heated garments. In some embodiments, the information is communicated to the user via one or more graphical user interface provided via the application on the external device 605 such that the user may create a dynamic preset that changes the heater array 26 temperature based on an amount of power left in the battery pack 1.

In some embodiments, the battery pack controller 100 adjusts multiple garments in parallel or sequentially (without requiring separate user input) when multiple heated garments are connected and the temperature of one heated garment is adjusted. For example, the controller 100 may communicate a temperature or adjust a temperature of the heated gloves 50 when the heated glove 50 is connected to the heated jacket 10. Thus, the controller 100 determines a total amount of power drawn from the battery cells 15 of the battery pack 1 to provide power to the heater array 26 of the heated jacket 10 and a heater array of the heated gloves 50. The controller 100 may also turn on and off multiple garments (e.g., the heated jacket 10 and the heated glove 50) in parallel or sequentially (without requiring separate user input) when one of the heated garments is turned on or off. The controller 100 operates as a master controller and the heated garment controllers 200, 215 operate based on the controls sent from controller 100.

FIG. 8A illustrates a first dual connector 400 from a heated garment, such as heated jacket 10 (FIG. 2). The first dual connector 400 connects the battery pack 1 to a plurality of different types of heated garments. In some embodiments, the first dual connector 400 extends as a wire from the heated jacket 10. The first dual connector 400 includes a dual barrel connection portion including a first connection portion 405 and a second connection portion 410. For example, the first connection portion 405 may be a barrel-style connector and the second connection portion 410 may be a USB-style connector. The first connection portion 405 facilitates power from the battery pack 1 to the heater array of the heated jacket 10 and the second connection portion 410 communicates data to the battery pack 1 from the heated jacket 10. In some embodiments, the first dual connector 400 may be a single connector that provides and receives both power and communications.

FIG. 8B illustrates a first dual connector port 415 of a battery pack, such as battery pack 1. The first dual connector port 415 receives the first dual connector 400 from the heated jacket 10 and facilitates an electrical connection between the battery pack 1 and the heated jacket 10. The first dual connector port 415 includes a first port 420 and a second port 425. The first port 420 receives the first connection portion 405 and the second port 425 receives the second connection portion 410. In some embodiments, the first port 420 is a 12V power port that provides a 27 watt (W) output and the second port 425 is a communication port. In some embodiments, the first dual connector port 415 facilitates the transfer of power and data from the battery pack 1 to the heated garment controller 200 and the heater array 26. For example, the power and data may be transferred from the battery pack 1 to the controller 200 via the power receive interface 220 of the controller 200. In some embodiments, the first dual connector port 415 may have an over current protection characteristic. For example, the over current protection characteristic enables the battery pack 1 to remain functional when an over-current event occurs. In some embodiments, the first dual connector port 415 may self-heal after the over-current event (e.g., after the first dual connector 400 is disconnected from the first dual connector port 415). In some embodiments, the battery pack 1 cannot receive power via the first dual connector port 415 (e.g., the battery pack 1 may not be charged via the first dual connector port 415).

FIG. 8C illustrates a second dual connector 430 from a heated garment, such as heated jacket 10 (FIG. 2). In some embodiments, the first dual connector 400 interfaces with a first battery pack and the second dual connector 430 interfaces with a second battery pack, such as battery pack 1. The second dual connector 430 connects the battery pack 1 to a plurality of different types of heated garments. In some embodiments, the second dual connector 430 extends as a wire from the heated jacket 10. The second dual connector 430 includes a dual barrel connection portion including a first connection portion 435 and a second connection portion 440. For example, the first connection portion 435 may be a barrel-style connector and the second connection portion 440 may also be a barrel-style connector that is smaller in diameter than the first connection portion 435. The first connection portion 435 facilitates power (e.g., 12V, 27 W) from the battery pack 1 to the heater array 26 of the heated jacket 10 and the second connection portion 440 communications data to the battery pack 1 from the heated jacket 10.

FIG. 8D illustrates a second dual connector port 445 of a battery pack, such as battery pack 1. The second dual connector port 445 receives the second dual connector 430 from the heated jacket and facilitates an electrical connection between the battery pack 1 and the heated jacket 10. The second dual connector port 445 includes a first port 450 and a second port 455. The first port 450 receives the first connection portion 435 and the second port 455 receives the second connection portion 440. In some embodiments, the first port 450 is a 12V power port that provides a 27 watt (W) output and the second port 455 is a communication port. In some embodiments, the second dual connector port 445 may have an over current protection characteristic. For example, the over current protection characteristic enables the battery pack 1 to remain functional when an over-current event occurs. In some embodiments, the second dual connector port 445 may self-heal after the over-current event (e.g., after the second dual connector 430 is disconnected from the second dual connector port 445). In some embodiments, the battery pack 1 cannot receive power via the second dual connector port 445 (e.g., the battery pack 1 may not be charged via the second dual connector port 445).

In some embodiments, the battery pack 1 is compatible with a plurality of heated garments, regardless of the age of production of the garment. In some embodiments, the battery pack 1 may provide power to any device with a dual connector 400, 430. In embodiments where the heated garment does not include a controller, the battery pack controller 100 may only monitor the power in the battery cells 15 of the battery pack 1. In embodiments where the heated garment does include a controller (e.g., heated jacket 10 including controller 200), the battery pack controller 100 is able to monitor the battery cells 15 and control the heated garment connected to the battery pack 1. Dual connectors 400, 430 allow the battery pack 1 to be used with a plurality of different types of heated garments, both old and new.

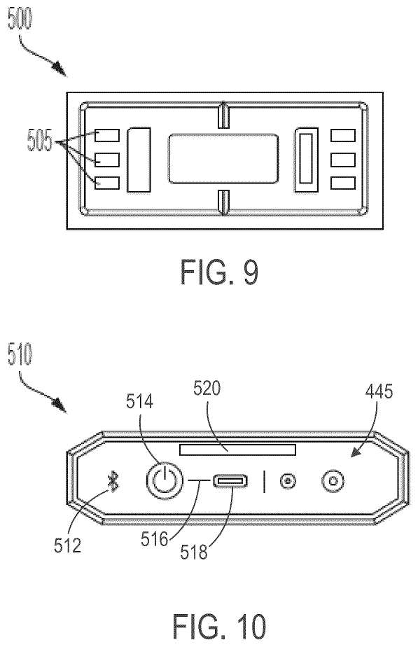

FIG. 9 illustrates a user interface 500 for the heated garment 10. The user interface 500 includes one or more lighting components 505, such as LEDs, that may change color and/or intensity. In some embodiments, the user interface 500 conveys information to a user wearing the heated garment by changing color and/or intensity of the lighting components 505. For example, based on input from an external device, such as external device 605, the battery pack controller 100 may adjust heat settings of the heated jacket 10. The adjusted heat settings may be conveyed to the user via the user interface 500. For example, the lighting components 505 of the user interface 500 may turn OFF when the heater array 26 of the heated jacket 10 is turned OFF. As another example, the lighting components 505 may turn a first color (e.g., blue, green, etc.) when the heated jacket 10 has been set to a user preset that the user defines via the external device 605 and communicates to the controller 100 via the Bluetooth® controller 115. As another example, the lighting components 505 may turn to a second color (e.g., red, orange, etc.) when the heated jacket 10 is operated in a manual mode. It should be understood that various colors, intensities, blinking patterns, or a combination thereof may be used to convey information via the user interface 500.

FIG. 10 illustrates a user interface 510 of the battery pack 1. The user interface 510 includes one or more interactive elements, such as one or more buttons, that send a signal to the battery pack controller 100 to perform a function and, in some embodiments, one or more passive elements, such as LEDs, that convey information to a user. For example, the user interface 510 may include a Bluetooth® LED 512, a power button 514, a USB-C activation LED 516, a USB-C port 518, a fuel gauge 520, and the second dual connector port 445. The Bluetooth® LED 512 may illuminate when the Bluetooth® controller 115 is paired with an external device 605 or when the Bluetooth® controller 115 is transmitting and/or receiving information from the external device 605. The power button 514 may be pressed to turn ON the battery pack 1 and may be pressed again to turn OFF the battery pack 1. As another example, the power button 514 may be pressed and held to pair the battery pack 1 with an external device, such as external device 605, via the Bluetooth® controller 115. The USB-C activation LED 516 may illuminate in response to the battery pack 1 providing a charging power via the USB-C port 518 to a device 118. For example, the battery pack 1 may provide 15 W when charging the device 118. In some embodiments, the USB-C activation LED 516 may illuminate in response to the battery pack 1 receiving charging power via the USB-C port 518 from the device 118. For example, the device 118 (or any other suitable device) may provide 36 W to the battery pack 1 to charge the battery cells 15. The fuel gauge 520 may display a level of charge of the battery cells 15 of the battery pack 1 when a dual connector 430 is received by the dual connector port 445 (e.g., at startup/power ON) and when a user depresses the power button 515. Additionally, the fuel gauge 520 may indicate an error status of the battery pack 1 (e.g., an overcurrent condition, an overtemperature condition, a loss of connection with the external device 605, etc.). In some embodiments, the fuel gauge 520 may include four LEDs.

FIG. 11 illustrates a communication network 600. As noted above, in some embodiments, the battery pack 1 communicates with an external device 605. In such embodiments, the battery pack 1 may include, for example, a wireless communication controller (e.g., the Bluetooth® controller 115) described above, which includes a transceiver to communicate with the external device 605 via, for example, a short-range communication protocol, such as Bluetooth®. The external device 605 may include a short-range transceiver, such as Bluetooth® controller 715 (FIG. 12), to communicate with the battery pack 1, and may also include a long-range transceiver, such as communication interface 720 (FIG. 1), to communicate with a server (not shown). In some embodiments, a wired connection (via, for example, a USB cable) is provided between the external device 605 and the battery pack 1 to enable direct communication between the external device 605 and the battery pack 1. Providing the wired connection may provide a faster and more reliable communication method between the external device 605 and the battery pack 1.

The external device 605 may include, for example, a smart telephone, a tablet computer, a cellular phone, a laptop computer, a smart watch, and any other communication device that is external to the battery pack 1. The external device 605 may communicate with the battery pack 1 and may generate one or more graphical user interfaces (e.g., applications in FIGS. 18-21) to provide information to a user of the external device 605, receive input from a user to adjust heat settings of the heated garments and/or operation of the battery pack 1, or a combination thereof.

FIG. 12 is a block diagram of the external device 605. In some embodiments, the external device 605 may include one or more processors 700, a memory 705, a user interface 710, the Bluetooth® controller 715, and the communication interface 720. A memory bus may be used for communication between the processor 700 and the memory 705.

The processor 700 may be, for example, an electronic processor, a microprocessor (μP), a microcontroller (μC), a digital signal processor (DSP), or a combination thereof. The processor 700 may include one or more levels of caching, such as a level cache memory, a processor core, and registers. The processor core may include an arithmetic logic unit (ALU), a floating point unit (FPU), a digital signal processing core (DSP Core), or any combination thereof. A memory controller may also be used with the processor 700, or in some implementations, the memory controller may be an internal part of the processor 700. In some embodiments, the memory 705 may include the heated gear application discussed with respect to FIGS. 18-21. For example, the processor 700 may execute the heated gear application (app) stored in the memory 705 based on input received at the user interface 710. Depending on the desired configuration, the memory 705 include, for example, volatile memory (such as RAM), non-volatile memory (such as ROM, flash memory, etc.), or a combination thereof.

The user interface 710 may include a hardware screen that may be communicatively coupled to the external device 605. The user interface 710 may include a touch sensitive device that detects gestures such as a touch action. The user interface 710 may also provide feedback in response to detected gestures (or other forms of input).

The Bluetooth® controller 715 enables the external device 605 to communicate with other Bluetooth® enabled devices, such as the Bluetooth® controller 115 of the battery pack 1, when the external device 605 is in range of the other devices. In some embodiments, the external device 605 may communicate with other devices over a network (not shown) via the communication interface 720. For example, the communication interface 720 may include a transceiver. As previously noted, the devices described herein are not limited to communicating via the Bluetooth® protocol and may use other forms and protocols of wireless communication.

The external device 605 may have additional features or functionality, and additional interfaces to facilitate communications between the external device 605 and other devices (e.g., battery pack 1) or networks. The external device 605 may also have additional internal components not illustrated in FIG. 12. For example, a bus/interface controller may be used to facilitate communications between the memory 705 and the processor 700, and the processor 700 may communicate with one or more data storage devices via a storage interface bus. The data storage devices may be one or more removable storage devices, one or more non-removable storage devices, or a combination thereof.

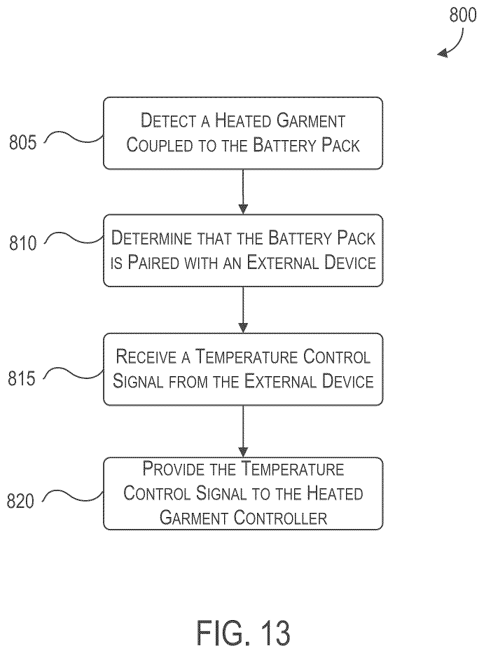

FIG. 13 is a method 800 of the battery pack 1 communicating with the external device 605. Although the illustrated method 800 includes specific steps, not all of the steps need to be performed or need to be performed in the order presented. In some embodiments, the method 800 is executed by the battery pack controller 100. Although the method 800 is described with respect to the heated jacket 10, any heated garment may be used.

The method 800 includes the controller 100 detecting a heated garment coupled to the battery pack 1 (step 805). In some embodiments, the controller 100 detects the heated jacket 10 is coupled to the battery pack 1 based on an input from at least one of a current sensor, a voltage sensor, and the power supply interface 125. In some embodiments, the controller 100 may detect multiple heated garments have been coupled to the battery pack 1.

In step 810 (and, in some embodiments, responsive to detecting a heated garment coupled to the battery pack 1), the controller 100 detects that the battery pack 1 is paired with an external device 605. For example, the controller 100 may detect that the Bluetooth® controller 115 of the battery pack 1 is paired with the Bluetooth® controller 715 of the external device 605. In some embodiments, the battery pack 1 may be paired with the external device in response to a user holding down the power button 514 of the battery pack 1. In step 815, the controller 100 receives a control signal from the external device 605. For example, the control signal may be communicated via Bluetooth®. Data included in the control signal may define at least one of a heat zone (e.g., chest, back pockets, etc.) temperature setting for the heater array 26 of the heated jacket 10, a runtime setting for at least one heat zone of the heater array 26, a heat zone selection, or an ON/OFF selection. In step 820, the controller 100 provides the control signal to the heated garment controller 200. In some embodiments, the controller 100 provides the control signal to the heated garment controller 200 in the same format and with the same data as received by the controller 100 from the external device 605. In other embodiments, the control signal provided to the heated garment controller 200 from the controller 100 varies from the control signal received by the controller 100 from the external device 605 and may include different data, a subset of the original data, or a combination as compared to the control signal received by the controller 100 from the external device 605. For example, prior to providing the control signal to the controller 200, the controller 100 may process data included in the control signal received from the external device and may provide the processed data in the control signal provided to the heated garment controller 200. For example, the control signal provided from the controller 100 to the controller 200 may include current draw data determined by the controller 100 that the heated garment controller 200 uses to determine how much current to draw from the battery pack 1 to provide the requested temperature setting and/or runtime setting for at least one heat zone. In some embodiments, the control signal (as received by the controller 100 and/or as provided from the controller 100 to the controller 200) includes data defining at least one of a temperature of a heater array 26 of the heated garment 10, a runtime of the heater array 26, an ON/OFF status of the heater array 26, a mode of the heater array 26, and a lockout of the heated garment 10.

In some embodiments, rather than transmitting the control signal to the controller 200 for implementation or application to the heater array 26, the controller 100 of the battery pack 1 directly controls the heater array 26 of the heated jacket 10 by providing or controlling an amount of power output by the battery pack 1 to the heater array 26 based on the control signal. In this configuration, the controller 100 may still communicate the control signal or other information to the controller 200, which the controller 200 may use to control one or more indicators on the heated garment 10.

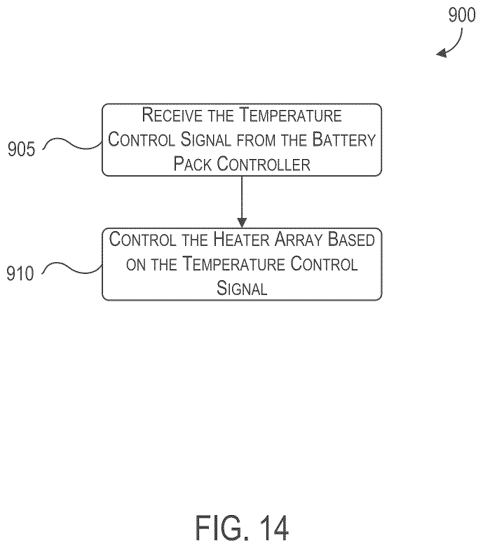

FIG. 14 is a method 900 of the controller 200 of the heated jacket 10 controlling the heater array 26. Although the illustrated method 900 includes specific steps, not all of the steps need to be performed or need to be performed in the order presented. In some embodiments, the method 900 is executed by the heated jacket controller 200. Although the method 900 is described with respect to the heated jacket 10, any heated garment may be used.

The method 900 includes the controller 200 receiving the control signal from the battery pack controller 100 (step 905). In some embodiments, the controller 200 may receive the control signal via a wired connection between the heated jacket 10 and the battery pack 1. In step 910, the controller 200 controls the heater array 26 based on the control signal. For example, the controller 200 may adjust a temperature and/or a runtime of at least one a heat zone (e.g., chest, back pockets) of the heater array 26. In some embodiments, the controller 200 controls the amount of power drawn from the battery pack 1 to control the heater array 26 based on the received control signal.

FIG. 15 is a method 1000 of providing a constant runtime for the heater array 26 of the heated jacket 10. Although the illustrated method 1000 includes specific steps, not all of the steps need to be performed or need to be performed in the order presented. In some embodiments, the method 1000 is executed by the heated jacket controller 200. Additionally, although the illustrated method 1000 is performed by the heated jacket controller 200, the battery pack controller 100 may also implement the method 1000. Although the method 1000 is described with respect to the heated jacket 10, any heated garment may be used. Also, the values of various thresholds or ranges described with respect to method 1000 are provided as non-limiting examples and other values for such parameters are possible and may vary based on the type or condition of the battery pack 1, the type or condition of the heated garment, other factors, or a combination thereof.

The method 1000 includes the controller 200 turning the heated jacket 10 ON (step 1005). In some embodiments, the heated jacket 10 is turned ON in response to a user actuating the power button 514 of the battery pack 1. Alternatively, in some embodiments, the heated jacket 10 may be turned on automatically when connected to the battery pack 1. As a further alternative, in some embodiments, the user interface 500 of the heated jacket 10 may include an ON/OFF button. In step 1010, the controller 200 sets an output PWM signal based on a user selected mode. In some embodiments, the user selected mode may be provided from the external device 605 via the battery pack 1. For example, a user may interact with the user interface 710 of the external device 605 to select a heater level (e.g., a number between 1-10, high, medium, low, etc.) for the heater array 26. The user interface 710 may display a graphical user interface that a user may interact with to set a selected mode for the heater array 26, as described below with respect to FIGS. 18-21. The controller 200 may store a table or other data storage structure that maps predetermined output PWM signals for each of a plurality of modes.

In decision step 1015, the controller 200 determines whether a mode of the heater array 26 has been changed. For example, the external device 605 may communicate a mode change to the battery pack 1 based on an input to the application received via the user interface 710. When the mode has changed (YES at decision step 1015), the method 1000 returns to step 1010 and the method proceeds from step 1010. When the mode has not been changed (NO at decision step 1015), the method 1000 proceeds to decision step 1020.

In decision step 1020, the controller 200 determines whether the temperature of the heater array 26 is greater than a maximum target temperature (e.g., 50° Celsius (C)) or a target temperature. For example, the target temperature may be set based on the selected mode. The target temperature may be in a range of 30-50° C. In some embodiments, the controller 200 receives input from a temperature sensor (e.g., a NTC thermistor or a PTC thermistor) that is adjacent to the heater array 26 to determine the temperature of the heater array 26. When the temperature of the heater array 26 is greater than 50° C. or a target temperature (YES at decision step 1020), the method 1000 proceeds to step 1025. When the temperature of the heater array 26 is not greater (e.g., less than or equal to) than 50° C. or a target temperature (NO at decision step 1020), the method 1000 proceeds to step 1030.

In step 1025 (when the temperature of the heater array 26 is greater than 50° C. or a target temperature), the controller 200 turns off the heater array 26. In some embodiments, the controller 200 obstructs the flow of power from the battery pack 1 to the heater array 26 by opening a switch. The method 1000 proceeds to step 1035.

In step 1030 (when the temperature of the heater array 26 is not greater (e.g., less than or equal to) than 50° C. or a target temperature), the controller 200 turns ON the heater array 26 with a fixed PWM. For example, the fixed PWM may correspond to the set PWM that is set based off a user selected mode. The method 1000 then proceeds to decision step 1035.

In decision step 1035, the controller 200 determines whether the heated jacket 10 is turned OFF. For example, the controller 200 may receive a signal from the battery pack controller 100 that the power button 514 has been turned OFF. When the controller 200 determines that the heated jacket 10 is turned OFF (YES at decision step 1035), the method 1000 proceeds to step 1040. When the controller 200 determines that the heated jacket 10 is not turned OFF (e.g., the heated jacket 10 is ON) (NO at decision step 1035), the method 1000 returns to decision step 1015 and proceeds from step 1015. In step 1040, the controller 200 turns off the heated jacket 10. For example, the controller 200 ceases power output to the heater array 26.

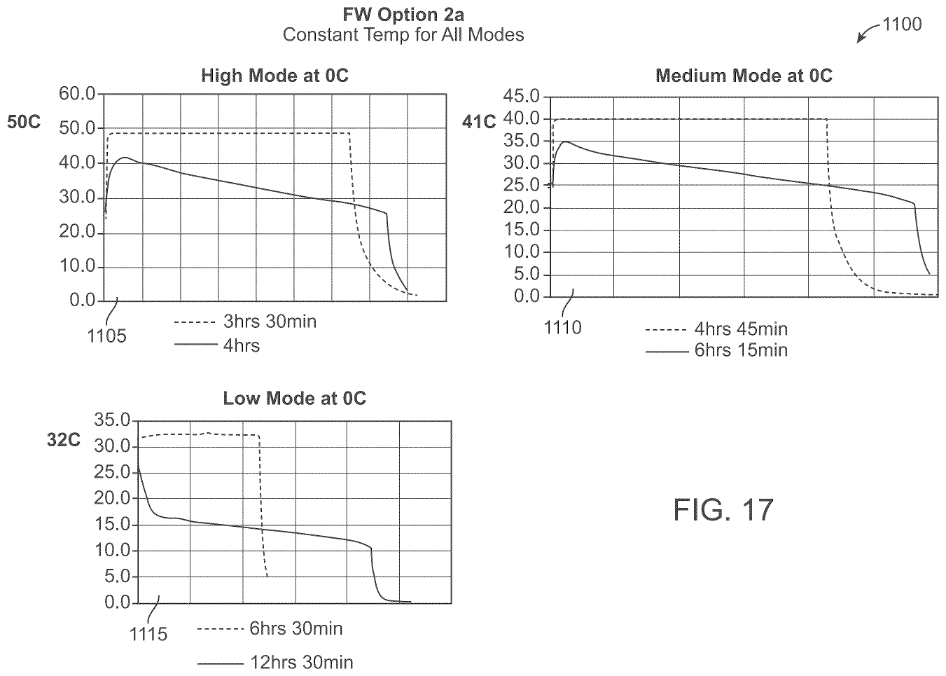

The method 1000 provides a known, consistent power draw from the battery pack 1 to the heater array 26 of the heated jacket 10. For example, as described above, an output PWM power signal is set in method 1000 and this power signal is used until a sensed temperature exceeds one or more thresholds. Thus, no changes to the power signal is made while the sensed temperature is less than the one or more thresholds, which means that in some embodiments, a target temperature is not reached. During this mode of operation, when the power from the battery cells 15 of the battery pack 1 drains, the temperature of the heater array 26 decreases. In a colder environment (e.g., when a high mode is selected), the runtime of the heater array 26 is known, however, the heater temperature may decrease to meet the demands of the runtime, as shown in FIG. 17 (described below).

FIG. 16 is a method 1050 of providing a constant temperature for the heater array 26 of the heated jacket 10. Although the illustrated method 1050 includes specific steps, not all of the steps need to be performed or need to be performed in the order presented. In some embodiments, the method 1050 is executed by the heated jacket controller 200. Additionally, although the illustrated method 1050 is performed by the heated jacket controller 200, the battery pack controller 100 may also implement the method 1050. Although the method 1050 is described with respect to the heated jacket 10, any heated garment may be used. Also, the values of various thresholds or ranges described with respect to method 1050 are provided as non-limiting examples and other values for such parameters are possible and may vary based on the type or condition of the battery pack 1, the type or condition of the heated garment, other factors, or a combination thereof. In some embodiments, the controller 200 is configured to implemented one of the methods 1000 and 1050. However, in other embodiments, the controller 200 may be configured to implement either of the methods 1000 and 1050 and may select one of the methods based on current operating conditions of the battery pack 1, the heated jacket 10, or the like, may select a method based on user input, or a combination thereof.

The method 1050 includes the controller 200 turning the heated jacket 10 ON (step 1055). In some embodiments, the heated jacket 10 is turned ON in response to a user actuating the power button 514 of the battery pack 1. Alternatively, in some embodiments, the heated jacket 10 may be turned on automatically when connected to the battery pack 1. As a further alternative, in some embodiments, the user interface 500 of the heated jacket 10 may include an ON/OFF button. In step 1060, the controller 200 sets a target temperature and PWM based on a user selected mode. In some embodiments, the user selected mode may be provided from the external device 605 via the battery pack 1. For example, a user may interact with the user interface 710 of the external device 605 to select a heater level (e.g., a number between 1-10, high, medium, low, etc.) for the heater array 26. The user interface 710 may display a graphical user interface that a user may interact with to set a selected mode for the heater array 26, as described below with respect to FIGS. 18-21.

In decision step 1065, the controller 200 determines whether a mode of the heater array 26 has been changed. For example, the external device 605 may communicate a mode change to the battery pack 1 based on an input to the application at the user interface 710. When the mode has changed (YES at decision step 1065), the method 1050 returns to step 1060 and the method proceeds from step 1060. When the mode has not been changed (NO at decision step 1065), the method 1050 proceeds to decision step 1070.

In decision step 1070, the controller 200 determines whether the temperature of the heater array 26 is greater than 50° C. In some embodiments, the controller 200 receives input from a temperature sensor (e.g., a NTC thermistor or PTC thermistor) that is adjacent to the heater array 26 to determine the temperature of the heater array 26. When the temperature of the heater array 26 is greater than 50° C. (YES at decision step 1070), the method 1050 proceeds to step 1072. When the temperature of the heater array 26 is not greater than (e.g., less than or equal to) 50° C. (NO at decision step 1070), the method 1050 proceeds to step 1075.

In step 1072 (when the temperature of the heater array 26 is greater than 50° C.), the controller 200 turns off the heater array 26. In some embodiments, the controller 200 obstructs the flow of power from the battery pack 1 to the heater array 26 by opening a switch. The method 1050 proceeds to step 1090 from step 1072.

In decision step 1075 (when the temperature of the heater array 26 is greater than 50° C.), the controller 200 determines whether the temperature of the heater array 26 is greater than a target temperature. For example, the target temperature may be set based on the selected mode. The target temperature may be in a range of 30-55° C. When the temperature of the heater array 26 is greater than the target temperature (YES at decision step 1075), the method 1050 proceeds to step 1072. When the temperature of the heater array 26 is not greater than (e.g., less than or equal to) the target temperature (NO at decision step 1075), the method 1050 proceeds to decision step 1080.

In decision step 1080 (when the temperature of the heater array 26 is not greater than (e.g., less than or equal to) the target temperature), the controller 200 determines whether the temperature of the heater array 26 is less than a target temperature. For example, the target temperature may be set based on the selected mode. The target temperature may be in a range of 30-55° C. When the temperature of the heater array 26 is less than the target temperature (YES at decision step 1080), the method 1050 proceeds to step 1085. When the temperature of the heater array 26 is not less than (e.g., equal to) the target temperature (NO at decision step 1080), the method 1050 returns to decision step 1065 and the method 1050 proceeds from decision step 1065.

In step 1085 (when the temperature of the heater array 26 is less than the target temperature (i.e., not equal to the target temperature)), the controller 200 turns ON the heater array 26. For example, the controller 200 enables power to flow from the battery pack 1 to the heater array 26. In some embodiments, the controller 200 turns ON the heater array 26 according to a PWM set based on the user selected mode in step 1060. In decision step 1090, the controller 200 determines whether the heated jacket 10 is turned OFF. For example, the controller 200 may receive a signal from the battery pack controller 100 that the power button 514 has been turned OFF. When the controller 200 determines that the heated jacket 10 is turned OFF (YES at decision step 1090), the method 1050 proceeds to step 1095. When the controller 200 determines that the heated jacket 10 is not turned OFF (e.g., the heated jacket 10 is ON) (NO at decision step 1090), the method 1050 returns to decision step 1065 and proceeds from step 1065. In step 1095, the controller 200 turns off the heated jacket 10. For example, the controller 200 ceases power output to the heater array 26.

The method 1050 provides a known, consistent temperature of the heater array 26 of the heated jacket 10, regardless of the charge status of the battery pack 1. The controller 200 sets a temperature and a PWM of the heater array 26 such that the heater array 26 may provide a requested temperature for as long as possible. In a colder environment, the runtime of the heater array 26 is unknown and the heater temperature may rapidly decrease once the battery pack 1 is depleted of charge, as shown in FIG. 17 (described below).

FIG. 17 illustrates graphs 1100 displaying constant runtime control and constant temperature control for the heated jacket 10. The graphs 1100 include a high mode graph 1105, a medium mode graph 1110, and a low mode graph 1115 that display the heater array 26 temperature in 0° C. conditions for both the constant runtime control (FIG. 15) and the constant temperature control (FIG. 16). When the controller 200 is controlling the heater arrays 26 to provide a constant runtime, the temperature output of the heater arrays 26 may never reach the maximum requested temperature for each mode. Rather, the temperature will begin in at a minimum acceptable value for the mode selected by a user (e.g., via the external device 605) and will slowly decline as the battery pack 1 discharges. When the controller 200 is controlling the heater arrays 26 to provide a constant temperature, the temperature output of the heater arrays remains at the requested temperature for the duration of the discharge of the battery pack 1. In response to the battery pack 1 reaching a threshold level (e.g., 0-5% remaining charge), power to the heater arrays 26 ceases. In some embodiments, using constant runtime control allows for a longer period of heat than constant temperature control. In some embodiments, using constant temperature control allows for a greater level of heat for a period of time than constant runtime control.

FIG. 18 illustrates a first screen (graphical user interface) 1200 generated by an example heated gear application (app) as provided on the user interface 710 of the external device 605 for a user to pair the battery pack 1 with the external device 605. On the first screen 1200, a connect button 1205 is provided for a user to select to connect the battery pack 1 to the external device 605 (e.g., via Bluetooth®). In some embodiments, the connect button 1205 appears on the first screen 1200 in response to a user depressing the power button 514 of the battery pack 1 for a first period of time (e.g., two seconds). For example, the Bluetooth® controller 115 of the battery pack 1 may be configured to send out pairing signals in response to detecting the power button 514 being depressed for the first period of time. In some embodiments, the external device 605 discovers the battery pack 1 (through receipt of one or more of the pairing signals) after a time period that is less than one second. For example, the Bluetooth® controller 115 of the battery pack 1 may broadcast a unique key (e.g., a UUID) and the Bluetooth® controller 715 of the external device 605 may capture the unique key. In some embodiments, a user may need to input a PIN code corresponding to the battery pack 1 at the user interface 710 of the external device 605 to authenticate the pairing between the battery pack 1 and the external device 605. The battery pack 1 and the external device 605 create a bond by sharing their addresses, names, and profiles which are stored in their respective memories (e.g., memory 145 of the battery pack 1, memory 705 of the external device 604).

The example heated gear application (app) may generate and provide (e.g., on the user interface 710) one of the second screen 1210, the third screen 1230, and the fourth screen 1250 in response to a selection of the connect button 1205 on the first screen. For example, the second screen 1210 may be provided when the battery pack 1 communicates to the external device 605 (e.g., via a heated garment connection signal) that a heated garment is connected to the battery pack 1 based on a determination that current is being provided from the battery cells 15. As another example, the third screen 1230 may be provided when the battery pack 1 communicates to the external device 605 (e.g., via a heated garment not connection signal) that a heated garment is not connected to the battery pack 1 based on a determination that current is not being provided from the battery cells 15. As another example, the fourth screen 1250 may be provided when the battery pack 1 communicates to the external device 605 (e.g., via a heated garment connection and charging signal) that a heated garment is connected to the battery pack 1 based on a determination that current is being provided from the battery cells 15 and, simultaneously, that current is being provided to the battery cells 15. The battery pack controller 100 may determine that a heated garment is connected to the battery pack 1 according to sensed currents and voltages, as described below with respect to FIG. 22. In some embodiments, the battery pack controller 100 determines what heated garment(s) are coupled to the battery pack 1 based on data provided by the heated garment controller 200 to the battery pack controller 100 when the heated garment is connected to the battery pack 1. For example, in some embodiments, the heated garment controller 200 may provide an identifier (e.g., a unique identifier, a model identifier, or the like) to the battery pack controller 100, which the controller 100 may forward to the heated gear app executed on the external device 605. The heated gear app may store (e.g., on the external device 605, a server, or a combination thereof) the identifier and associate the identifier with additional information, such as a user-specified name or description, user preferences, or the like. In some embodiments, historical usage information of the heated garment may also be stored with the associated identifier, which may allow the heated gear app to develop a profile for a particular heated garment and suggest default heating settings.

In some embodiments, when a second heated garment (e.g., heated glove 50) is coupled to the heated garment (e.g., heated jacket 10), the heated garment controller 200 provides data indicating that the second heated garment (or any number of additional heated garments) is coupled to the heated garment to the battery pack controller 100. The heated garment controller 200 may detect the coupling of the second heated garment similar to how the battery pack 1 detects a coupled heated garment. Alternatively or in addition, the battery pack controller 100 may detected the coupling of the second heated garment. As described above, when multiple heated garments are connected, the battery pack controller 100 may provide an identifier of each coupled heated garment to the external device 605 (i.e., the heated gear app) when the battery pack 1 pairs with the external device 605.

It should be understood that the battery pack controller 100, the external device 605 (i.e., the heated gear app), and the controller 200 of each connected heated garment may communicate in various configurations. For example, in some embodiments, a controller 200 in a heated garment may communicate directly with the external device 605 in addition to or as an alternative to communicating with the battery pack controller 100. Also, in some embodiments, the controller in each connected heated garment may be configured to communicate with the battery pack controller 100. Alternatively, one controller may be designated as a main controller and may control or relay data and power to one or more secondary controllers in additional heated gear. although the user interfaces described herein may illustrate controls for one connected heated garment, it should be understood that similar user interfaces may be provided for each connected heated garment and, in some embodiments, the heated gear app may provide a dashboard or similar output that includes information on multiple connected garments and allows a user to set heating parameters for multiple heated garments, multiple arrays within such heated garments, or a combination thereof, such as, for example, setting a heating parameter to be applied to each heated garment. Similarly, as described above, the heated gear app may maintain a profile of each connected garment, which may allow a user to manually specify preferences for particular gear (e.g., default settings to apply when connected), may allow the heated gear app to automatically track or learn such preferences, or a combination thereof. Furthermore, in some embodiments, the heated gear app may communicate with multiple battery pack controllers 100 as described herein, such as, for example, when a user is wearing or using multiple heated garments, some of which are powered by different battery packs.

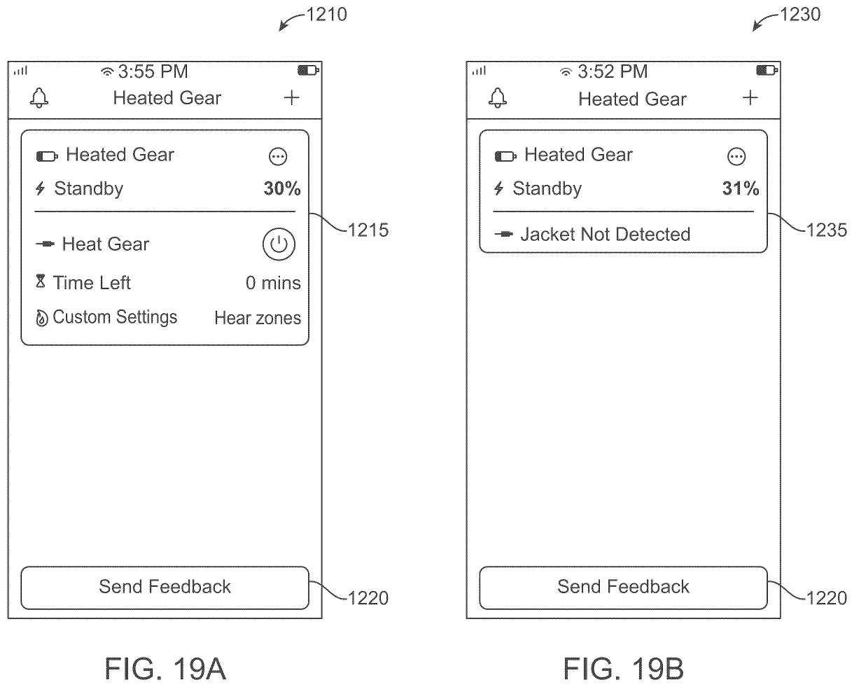

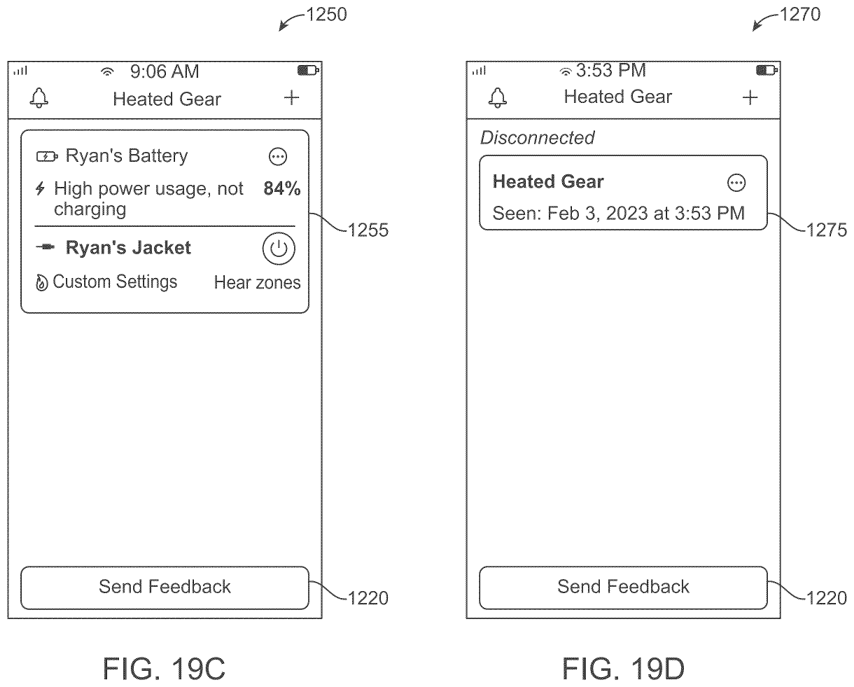

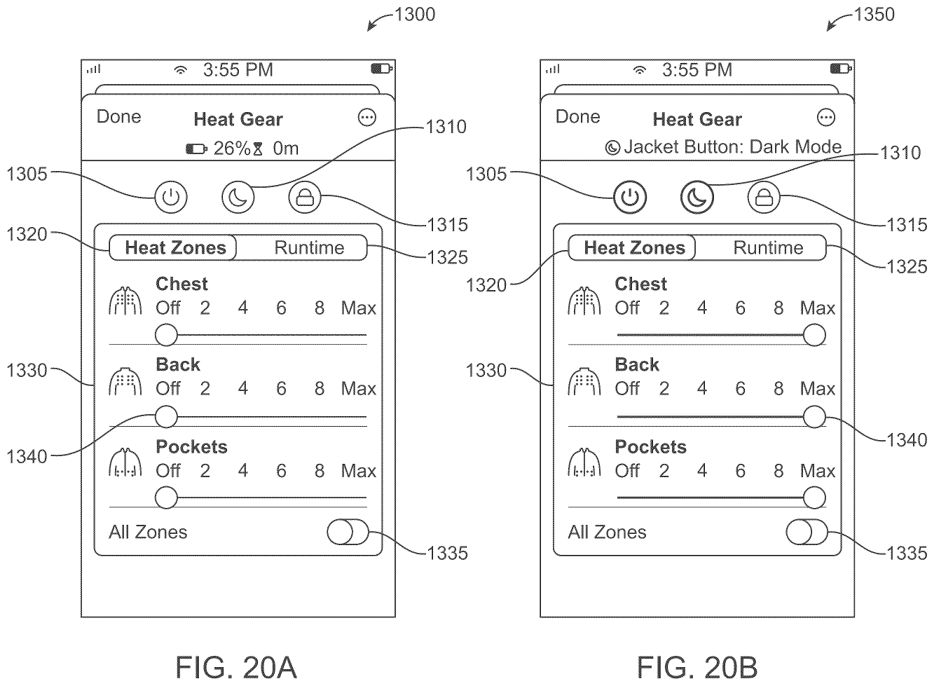

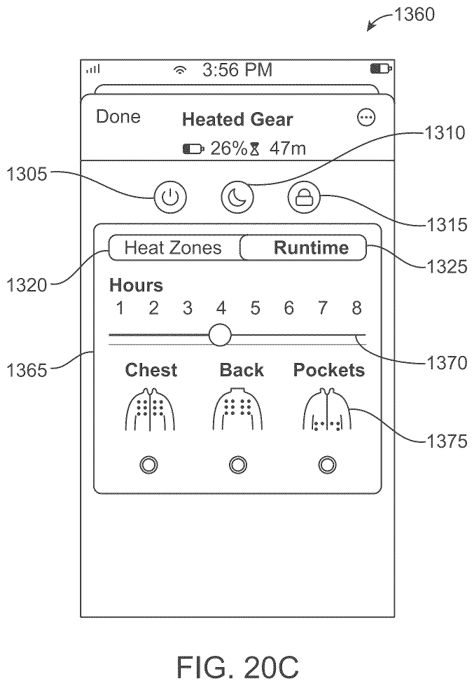

FIG. 19A illustrates a second screen (graphical user interface) 1210 generated by the example heated gear app as provided on the user interface 710 of the external device 605 after the battery pack 1 is paired with the external device 605. In some embodiments, the heated gear app automatically provides the second screen 1210 in response to the user selecting the connect button 1205 on the first screen 1200. In some embodiments, the second screen 1210 provides first battery pack information 1215 when a heated garment (e.g., heated jacket 10) is connected to the battery pack 1. The first battery pack information 1215 may include a name of the battery pack 1, a battery pack 1 name editing button, a battery pack 1 status (e.g., standby, charging, discharging, etc.), a battery pack 1 state of charge, a name of the heated jacket 10 connected to the battery pack 1, one or more custom settings, or a combination thereof. During discharge of the battery pack 1, the battery pack 1 state of charge decreases. During charging of the battery pack 1, the battery pack 1 state of charge increases. The custom settings may display which mode the heater array 26 of the heated jacket 10 is being operated in. For example, the mode may specify which heat zones of the heater array 26 are being operated, the runtime of the heater array 26, or that the heater array 26 is being operated in a manual mode (e.g., the heater array 26 is controlled via the interface 500 of the heated jacket 10). The custom settings may include a selectable button that is displayed as text (e.g., “Heat zones”) that, when selected by a user, brings a user to a sixth screen 1300 (FIG. 20A). In some embodiments, the external device 605 (i.e., executing the example heated gear app) determines a status of the battery pack 1 every 30 seconds.

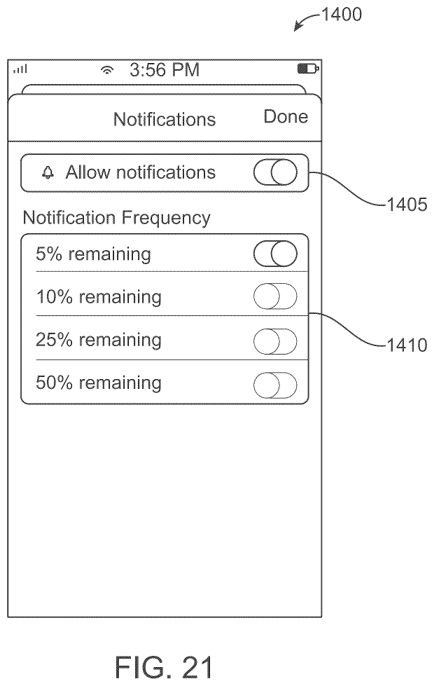

In some embodiments, the second screen 1210 may include a send feedback button 1220 that a user may select to send feedback, via the external device 605, to a manufacturer of the battery pack 1. Additionally, in some embodiments, the second screen 1210 may include a selectable button related to notifications that displays a ninth screen 1400 (FIG. 21) when selected and another selectable button related to pairing additional battery packs 1 with the external device 605.

FIG. 19B illustrates a third screen (graphical user interface) 1230 generated by the example heated gear app as provided on the user interface 710 of the external device 605 after the battery pack 1 is paired with the external device 605. In some embodiments, the example heated gear app automatically provides the third screen 1230 in response to the user selecting the connect button 1205 on the first screen 1200. In some embodiments, the third screen 1230 provides second battery pack information 1235 when a heated garment (e.g., heated jacket 10) is not connected to the battery pack 1. The second battery pack information 1235 may include a name of the battery pack 1, a battery pack 1 name editing button, a battery pack 1 status (e.g., standby, charging, discharging, etc.), a battery pack 1 state of charge, a jacket connection status (e.g., jacket not connected), or a combination thereof. In response to pairing with the battery pack 1, the example heated gear app may determine whether a heated garment is connected to the battery pack in less than one second (e.g., based on a signal provided by the battery pack 1). In some embodiments, the external device 605 (i.e., executing the heated gear app) determines a status of the battery pack 1 every 30 seconds. In some embodiments, the third screen 1230 may include the send feedback button 1220. Additionally, in some embodiments, the third screen 1230 may include a selectable button related to notifications that displays the ninth screen 1400 (FIG. 21) when selected and another selectable button related to pairing additional battery packs 1 with the external device 605.

FIG. 19C illustrates a fourth screen (graphical user interface) 1250 generated by the example heated gear app as provided on the user interface 710 of the external device 605 after the battery pack 1 is paired with the external device 605. In some embodiments, the example heated gear app automatically provides the fourth screen 1250 in response to the user selecting the connect button 1205 on the first screen 1200. In some embodiments, the fourth screen 1250 provides third battery pack information 1255 when a heated garment (e.g., heated jacket 10) is connected to the battery pack 1 and the battery pack 1 is connected to a charging source. The third battery pack information 1255 may include a name of the battery pack 1, a battery pack 1 name editing button, a battery pack 1 status (e.g., high power usage, not charging, etc.), a battery pack 1 state of charge, a name of the heated jacket 10 connected to the battery pack 1, one or more custom settings, or a combination thereof. In some embodiments, the battery pack 1 fluctuates between charging and discharging when connected to the heated jacket 10 and a power source that is providing charging power. For example, when power usage of the battery pack 1 is too high (e.g., in a high mode of operation) the battery pack 1 may not be charged. During simultaneous charging and discharging (e.g., providing power to the heater array 26 of the heated jacket 10), the battery pack 1 state of charge may increase or decrease (e.g., depending on the power draw of the heater array 26 and the charging current). In some embodiments, the external device 605 determines a status of the battery pack 1 every 30 seconds. In some embodiments, the fourth screen 1250 may include the send feedback button 1220. Additionally, in some embodiments, the fourth screen 1250 may include a selectable button related to notifications that displays the ninth screen 1400 (FIG. 21) when selected and another selectable button related to pairing additional battery packs 1 with the external device 605.

FIG. 19D illustrates a fifth screen (graphical user interface) 1270 generated by the example heated gear app as provided on the user interface 710 of the external device 605 when the battery pack 1 is disconnected from the external device 605. In some embodiments, the example heated gear app automatically provides the fifth screen 1270 in response to at least one of the battery pack 1 becoming out of range of the external device (e.g., out of a Bluetooth® range of the battery pack), a user turning off the battery pack 1 (e.g., by pressing the power button 514 of the), and battery cells 15 of the battery pack 1 becoming depleted (e.g., state of charge of the battery pack 1 being 0%, as no power may be available for powering the wireless communication controller of the battery pack 1). In some embodiments, the fifth screen 1270 provides fourth battery pack information 1275. The fourth battery pack information 1275 may include last known connection information (e.g., a date and time) for a heated garment connected to the battery pack 1 that was previously connected to the external device 605. In some embodiments, the fifth screen 1270 may include the send feedback button 1220. Additionally, in some embodiments, the fifth screen 1270 may include a selectable button related to notifications (e.g., a bell-shaped button) that displays the ninth screen 1400 (FIG. 21) when selected and another selectable button related to pairing additional battery packs 1 with the external device 605.

FIG. 20A illustrates the sixth screen (graphical user interface) 1300 generated by the example heated gear app as provided on the user interface 710 of the external device 605 when a user selects the button that is displayed as text (e.g., “Heat zones”) as a part of the first battery pack information 1215 on the second screen 1210. In some embodiments, the sixth screen 1300 includes a heated jacket ON/OFF button 1305, a heated jacket dark mode button 1310, a heated jacket lockout button 1315, a selectable heat zones tab 1320, a runtime tab 1325, and heat zone customization information 1330. The heat zone customization information 1330 enables a user to personalize zones of the heater array 26 of the heated jacket 10 that are heated, as well as the heat level of the zones. For example, a user may drag a temperature selection slider 1340 between OFF and “MAX” (e.g., no power provided to the zone to maximum power provided to the zone) to select a temperature level of at least one zone. In some embodiments, when the temperature selection slider 1340 is adjusted from OFF when each temperature selection slider 1340 is in the OFF position, the heated jacket 10 is turned ON. A user may select the all zones button 1335 to apply any changes from one heater array to each heater zone of the heater array 26.

In some embodiments, when each temperature selection slider 1340 is in the OFF position and the ON/OFF button 1305 is turned ON, the heater zones of the heater array 26 (e.g., chest, back, and pockets of the heated jacket 10) are adjusted to a maximum setting. In some embodiments, selection of the heated jacket dark mode button 1310 dims one or more indicators on the heated jacket 10. In some embodiments, when the heated jacket lockout button 1315 is selected, the external device 605 provides a lockout signal to one of the battery pack controller 100 and the heated garment controller 200 that locks the heated jacket 10 user interface 500 so no inputs (e.g., adjusting the temperature of the heater array) may be received (e.g., user input through the user interface 500 is ignored or disregarded). In some embodiments, the sixth screen 1300 includes a state of charge of the battery pack 1 indication and an estimated runtime of the battery pack 1. Additionally, in some embodiments, the sixth screen 1300 includes a selectable button that provides the second screen 1210 and a selectable button related to editing the name of the heated jacket 10.

FIG. 20B illustrates a seventh screen (graphical user interface) 1350 generated by the example heated gear app as provided on the user interface 710 of the external device 605. The seventh screen 1350 may include similar buttons and information as the sixth screen 1300. In the example version of the seventh screen 1350 illustrated in FIG. 20B, the heated jacket ON/OFF button 1305 is ON and the heated jacket dark mode button 1310 is ON, as indicated by the shading of the buttons. In some embodiments, the seventh screen 1350 provides text information to further display settings of the heated jacket 10 (e.g., indicating that the heated jacket 10 is on and is in dark mode).

FIG. 20C illustrates an eighth screen (graphical user interface) 1360 generated by the example heated gear app as provided on the user interface 710 of the external device 605 when a user selects the runtime tab 1325. In some embodiments, the eighth screen 1360 includes the heated jacket ON/OFF button 1305, the heated jacket dark mode button 1310, the heated jacket lockout button 1315, the selectable heat zones tab 1320, the runtime tab 1325, and heat zone runtime customization information 1365. The heat zone runtime customization information 1365 enables a user to personalize the runtime of zones of the heater array 26. For example, a user may drag a runtime selection slider 1370 between a first value (e.g., “1”) and a second value (e.g., “8”) to select a runtime of at least one zone. A user may also toggle between the zones of the heater array 26 by selecting a particular zone representation 1375 within the user interface. In some embodiments, the eighth screen 1360 includes a state of charge of the battery pack 1 indication and an estimated runtime of the battery pack 1. In some embodiments, the estimated runtime of the battery pack 1 decreases as the battery pack 1 is discharged. Additionally, in some embodiments, the eighth screen 1360 may include a selectable button that, when selected, provides the second screen 1210 and a selectable button related to editing the name of the heated jacket 10.

FIG. 21 illustrates a ninth (graphical user interface) screen 1400 generated by the example heated gear app as provided on the user interface 710 of the external device 605 when a user selects the selectable button related to notifications (e.g., a bell-shaped button on the screen). In some embodiments, the ninth screen 1400 includes an allow notification button 1405 and notification frequency customization buttons 1410. The allow notification button 1405 may be toggled ON/OFF by a user. In the ON state, notifications regarding the battery pack 1 and the heated jacket 10 may be provided to the external device 605. In the OFF state, notifications regarding the battery pack 1 and the heated jacket 10 may not be provided to the external device 605. The notification frequency customization buttons 1410 may include buttons corresponding to states of charge of the battery pack 1. For example, the external device 605 may display a notification when the state of charge of the battery pack 1 is one of 5%, 10%, 25%, and 50%. Additionally, in some embodiments, the sixth screen 1300 may include a selectable button that, when selected, provides the second screen 1210.

The graphical user interfaces provided in FIGS. 18-21 enables a user to customize settings (e.g., temperature, runtime, heater zones, heated garment personalization, etc.) at least one heated garment. In some embodiments, a user may adjust the heater array 26 of the heated jacket 10 to provide a high output so that the user feels a high level of warmth. A user may toggle between graphical user interfaces to customize the settings. For example, the user may select buttons on the graphical user interfaces to achieve a desired level of warmth for a desired amount of time. The graphical user interfaces may convey battery pack information (e.g., state of charge, charging status, etc.) to a user.

FIG. 22 illustrates a protection circuit 1500 for the battery pack 1. In some embodiments, the protection circuit 1500 includes the controller 100 that monitors the current used by the DC jack (e.g., one of the first dual connector port 415 and the second dual connector port 445). For example, a first resistor R136 and a second resistor R137 may be used to determine the current drawn by the DC jack. In some embodiments, when the current drawn by the DC jack is above a threshold value (e.g., 12V), the controller 100 may inactivate a first switch Q13 which ceases power flow to the DC jack. Additionally, in some embodiments, the protection circuit 1500 may include a fuse for over-current protection.

In some embodiments, the controller 100 determines a power level of the battery cells 15 of the battery pack 1 by sensing a voltage change of a b pin (e.g., first port 420, 450). When a heated garment (e.g., heated jacket 10) is not connected to the battery pack 1, the b pin is pulled to ground via a c pin. In response to the heated jacket 10 being connected to the battery pack 1, the b pin is disconnected from the c pin and is pulled up through a third resistor R130, which signals to the controller 100 that a heated jacket 10 is connected to the battery pack 1.

Thus, embodiments described herein provide, among other things, a battery pack with a control unit for controlling a heated garment and wirelessly communicating with an external device. Various features and advantages are set forth in the following claims.

What is claimed is:

1. A power source for a heated garment, comprising:
a housing;
one or more battery cells located within the housing;
a first electrical interface provided on the housing for connecting the power source to the heated garment; and
a first controller located within the housing and including an electronic processor, a memory, and a transceiver, the first controller coupled to the battery cells and the first electrical interface, the first controller configured to:
detect the heated garment coupled to the power source at the first electrical interface,
receive, with the transceiver, a control signal from an external device, and
provide the control signal to a second controller included in the heated garment.

2. The power source of claim 1, wherein the first controller detects that the heated garment is coupled to the power source based on input from at least one of a current sensor, a voltage sensor, and a power supply interface of the power source.

3. The power source of claim 1, wherein the control signal includes data defining at least one of a temperature of a heater array of the heated garment, a runtime of the heater array, an ON/OFF status of the heater array, a mode of the heater array, and a lockout of the heated garment.

4. The power source of claim 1, wherein the first electrical interface includes a dual connection port for transmitting power and data to one or more components of the heated garment via a wired connection.

5. The power source of claim 1, wherein the power source wirelessly communicates with the external device using a short-range wireless transceiver.

6. The power source of claim 5, wherein the short-range wireless transceiver is a Bluetooth® transceiver.

7. The power source of claim 1, wherein the power source further includes a second electrical interface for transmitting power and receiving power.

8. The power source of claim 7, wherein the second electrical interface includes a USB-C port.

9. The power source of claim 7, wherein the power source further includes a power button and an indicator.

10. The power source of claim 9, wherein the first electrical interface, the second electrical interface, the power button, and the indicator are provided on a first side of the power source.

11. The power source of claim 10, wherein the first side is a front side of the power source that is perpendicular to both a flat side of the power source and a long side of the power source.

12. The power source of claim 1, wherein the power source is configured to be received by a compartment within the heated garment.

13. A method of providing a control signal to a heated garment, the method comprising:
detecting, with a first controller of a power source, the heated garment coupled to the power source at a first electrical interface,
receiving, with a transceiver of the power source, a control signal from an external device, and
providing, with the first controller of the power source, the control signal to a second controller of the heated garment.

14. The method of claim 13 further comprising:
receiving, with the second controller of the heated garment, the control signal, and
controlling, with the second controller of the heated garment, a heater array of the heated garment based on the control signal.

15. The method of claim 13, further comprising processing, with the first controller of the power source, the control signal prior to providing the control signal to the second controller.

16. A system comprising:
a heated garment including a heater array and a first controller; and
a power source including:
a housing;
one or more battery cells located within the housing;
a first electrical interface provided on the housing for connecting the power source to the heated garment; and
a second controller located within the housing and including an electronic processor, a memory, and a transceiver, the second controller coupled to the battery cells and the first electrical interface, the second controller configured to:
detect the heated garment coupled to the power source at the first electrical interface,
receive, with the transceiver, a control signal from an external device, and
provide the control signal to the first controller of the heated garment.

17. The system of claim 16, wherein the first electrical interface is a dual connector port.

18. The system of claim 17, wherein the dual connector port includes a communication port and a power port.

19. The system of claim 16, wherein the power source further includes a second electrical interface for providing power to the power source and providing power to the external device from the power source.

20. The system of claim 19, wherein the second electrical interface is a USB-C port.
